(19) United States
(12) Patent Application Publication
(10) Pub. No.: US 2021/0082293 A1
(43) Pub. Date: Mar. 18, 2021

(54) UNMANNED AERIAL VEHICLE CONTROL METHOD AND DEVICE

(71) Applicant: SZ DJI TECHNOLOGY CO., LTD., Shenzhen (CN)

(72) Inventors: Chang GENG, Shenzhen (CN); Hongzhu ZHOU, Shenzhen (CN)

(21) Appl. No.: 16/915,209

(22) Filed: Jun. 29, 2020

Related U.S. Application Data
(63) Continuation of application No. PCT/CN2017/120199, filed on Dec. 29, 2017.

(51) Int. Cl. G08G 5/00; H04L 29/06; B64C 39/02

(52) U.S. Cl. CPC G08G 5/0069; G08G 5/0013; G08G 5/006; B64C 2201/146; B64C 39/024; B64C 2201/127; H04L 63/0428

(57) ABSTRACT

A method for controlling an unmanned aerial vehicle includes receiving update data of a flight restriction database of the unmanned aerial vehicle returned by a server in response to an updating request and carrying current position information of the unmanned aerial vehicle, and, if the update data satisfies a condition controlling, controlling flight of the unmanned aerial vehicle according to the update data.

### CROSS-REFERENCE TO RELATED APPLICATION

This application is a continuation of International Application No. PCT/CN2017/120199, filed Dec. 29, 2017, the entire content of which is incorporated herein by reference.

### TECHNICAL FIELD

The present disclosure relates to the unmanned aerial vehicle control field, and more particularly, to an unmanned aerial vehicle control method and device.

### BACKGROUND

A flight restriction region includes a fixed flight restriction region and a temporary flight restriction region. The fixed flight restriction region includes a sensitive region, e.g., an airport, a prison, or a nuclear power plant, etc., which does not change the attribute of flight restriction with time. The temporary flight restriction region is generally divided due to an event, e.g., a match, a political activity, or a fire accident, etc. Differing from the fixed flight restriction region, the temporary flight restriction region is time-sensitive, that is, it takes effect within a specific period of validity, and is invalid if it exceeds the period of validity. An ability of an unmanned aerial vehicle to obtain a flight restriction data in time is one of the necessary conditions for a safe flight of the unmanned aerial vehicle.

In existing technologies, a method for realizing the time validity of the flight restriction region (including the temporary flight restriction region) is determining by a terminal (specifically, an APP installed on the terminal). Specifically, the terminal obtains a flight restriction database and determines the time validity of the flight restriction region. In this case, the data in the flight restriction database obtained certainly plays a role of restriction, so that the unmanned aerial vehicle does not need any other judgment and may directly extract the data from the flight restriction database to determine the flight restriction. On one hand, the logic of the unmanned aerial vehicle is simple and an amount of data transmitted from the terminal to the unmanned aerial vehicle can be reduced. On the other hand, if the terminal is excessively relied, and after the flight restriction database is configured for the unmanned aerial vehicle, the unmanned aerial vehicle is not connected to the terminal, causing the terminal not able to update the light restriction database, the flight restriction region will always take effect within the unmanned aerial vehicle even it has already exceeded a period of validity.

### SUMMARY

In accordance with the disclosure, there is provided a method for controlling an unmanned aerial vehicle including receiving update data of a flight restriction database of the unmanned aerial vehicle returned by a server in response to an updating request and carrying current position information of the unmanned aerial vehicle, and, if the update data satisfies a condition, controlling flight of the unmanned aerial vehicle according to the update data.

Also in accordance with the disclosure, there is provided a device for controlling an unmanned aerial vehicle including a storage device storing program instructions and a processor configured to execute the program instructions to receive update data of a flight restriction database of the unmanned aerial vehicle returned by a server in response to an updating request and carrying current position information of the unmanned aerial vehicle, and, if the update data satisfies a condition, control flight of the unmanned aerial vehicle according to the update data.

### BRIEF DESCRIPTION OF THE DRAWINGS

FIG. 1 is a structural block diagram of an unmanned aerial vehicle system according to one embodiment of the present disclosure.

FIG. 2 is a structural block diagram of an unmanned aerial vehicle system according to another embodiment of the present disclosure.

FIG. 3 is a flowchart of a method for controlling the unmanned aerial vehicle implemented by the unmanned aerial vehicle according to one embodiment of the present disclosure.

FIG. 4 is a schematic diagram showing the flight of the unmanned aerial vehicle according to one embodiment of the present disclosure.

FIG. 5A is a flowchart of a method for controlling the unmanned aerial vehicle implemented by the unmanned aerial vehicle according to another embodiment of the present disclosure.

FIG. 5B is a flowchart of a function of a user requesting to unlock an unmanned aerial vehicle according to one embodiment of the present disclosure.

FIG. 5C is a flowchart of a function of a user requesting to unlock an unmanned aerial vehicle according to another embodiment of the present disclosure.

FIG. 6 is a flowchart of a method for controlling the unmanned aerial vehicle implemented by a server according to one embodiment of the present disclosure.

FIG. 7 is a flowchart of a method for controlling the unmanned aerial vehicle implemented by the server according to another embodiment of the present disclosure.

FIG. 8 is a structural block diagram of an unmanned aerial vehicle system according to another embodiment of the present disclosure.

FIG. 9 is a structural block diagram of an unmanned aerial vehicle system according to another embodiment of the present disclosure.

FIG. 10 is a flowchart of a method for controlling the unmanned aerial vehicle implemented by the terminal according to one embodiment of the present disclosure.

FIG. 11 is a flowchart of a method for controlling the unmanned aerial vehicle implemented by the terminal according to another embodiment of the present disclosure.

### DETAILED DESCRIPTION OF THE EMBODIMENTS

Technical solutions of the present disclosure will be described in detail with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The unmanned aerial vehicle control method and device of the present disclosure will be described in detail below with reference to the drawings. In the case of no conflict, the features of the following examples and implementations can be combined with each other.

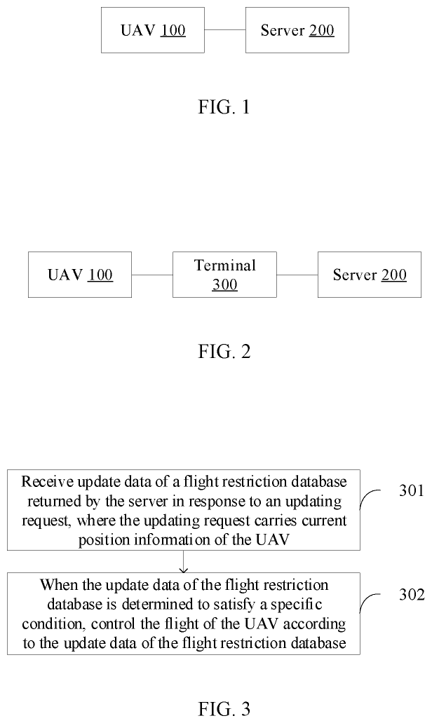

In some embodiments, as shown in FIG. 1, an unmanned aerial vehicle 100 is in an online status, and can be directly communicatively connected to a server 200 without a transfer by a terminal 300. Online refers to a device being connected to a local area network through a wireless means such as wife or a base station, etc.

In some embodiments, as shown in FIG. 2, the unmanned aerial vehicle 100 is in an offline status, and needs to realize communicative connection with a server 200 through a terminal 300 controlling the unmanned aerial vehicle 100. The unmanned aerial vehicle 100 being in the offline status means that the unmanned aerial vehicle 100 is not capable of connecting to the network, or the unmanned aerial vehicle 100 is capable of connecting to the network but is currently not convenient to connect to the network.

The terminal 300 is communicatively connected to the unmanned aerial vehicle 100 through networking or through transfer by a remote control, where the terminal 300 may be a device with an application (APP) installed thereon, e.g., a smart device such as a mobile phone or a tablet computer, etc.

The server 200 is at least provided with a dynamic flight restriction database to store information of a temporary flight restriction region (e.g., range information of the temporary flight restriction region). The server 200 is also provided with a static flight restriction database to store information of a fixed flight restriction region (e.g., range information of the fixed flight restriction region). In some embodiments, by providing the static flight restriction database and the dynamic flight restriction database in the server 200, the information of the fixed flight restriction region and the information of the temporary flight restriction region are stored, respectively, and a characteristic of slow change in fixed flight restriction region and frequency change in temporary flight restriction region is fully considered. When the unmanned aerial vehicle 100 or the terminal 300 requests to update a flight restriction data, the provided dynamic flight restriction database and static flight restriction database can facilitate selection of the update data, avoiding updating large amount of data each time in the unmanned aerial vehicle 100 or the ground device. Forms of the dynamic flight restriction database and the static flight restriction database to store data in the server 200 are not limited.

In order to ensure the safety of flight, the unmanned aerial vehicle 100 needs to obtain the flight restriction data. In some embodiments, the unmanned aerial vehicle 100 may directly obtain the flight restriction data from the server 200. In some other embodiments, the terminal 300 directly obtains the flight restriction data from the server 200 and then forwards the flight restriction data to the unmanned aerial vehicle 100.

In one embodiment, there is provided an unmanned aerial vehicle control method. FIG. 3 is the flowchart of the method for controlling the unmanned aerial vehicle. The method can be implemented by, e.g., the unmanned aerial vehicle 100, for example, by a flight controller of the unmanned aerial vehicle 100 or another processor of the unmanned aerial vehicle 100.

In some embodiments, the unmanned aerial vehicle 100 is provided with a dynamic flight restriction database and a static flight restriction database, where the dynamic flight restriction database can conveniently store obtained information of a temporary flight restriction region and facilitate frequent update of the information of the temporary flight restriction region. The unmanned aerial vehicle 100 includes a cache, e.g., an electrically erasable programmable read-only memory (EEPROM), and the flight restriction database is stored in the cache, thereby facilitating an upgrade of the flight restriction database. The static flight restriction database is configured to store information of fixed flight restriction region, so as to ensure the safe flight of the unmanned aerial vehicle 100. The unmanned aerial vehicle 100 may further include a fixed storage. Due to its low changing frequency, the static flight restriction database can be stored in the fixed storage. The static flight restriction database can be directly provided in the unmanned aerial vehicle 100 when the unmanned aerial vehicle leaves the factory. After the unmanned aerial vehicle 100 leaves the factory, if the static flight restriction database of the server 200 changes or the static flight restriction database of the unmanned aerial vehicle needs update for other reasons, the static flight restriction database of the unmanned aerial vehicle can be updated through, e.g., firmware update, etc. It is noted that, forms of the dynamic flight restriction database and the static flight restriction database to store data are not limited.

In some embodiments, since the unmanned aerial vehicle 100 is provided with the static flight restriction database and the dynamic flight restriction database, the information of the fixed flight restriction region and the information of the temporary flight restriction region are stored separately, and a characteristic of slow change in the fixed flight restriction region and frequency change in the temporary flight restriction region is considered. When the unmanned aerial vehicle 100 needs to update the flight restriction data, only one of the dynamic flight restriction database and the static flight restriction database is selected, to avoid updating large amount of data each time in the unmanned aerial vehicle 100. On the other hand, the dynamic flight restriction database and the static flight restriction database can also be updated simultaneously to ensure the integrity of the flight restriction data, thereby ensuring the safety of the flight of the unmanned aerial vehicle 100.

As shown in FIG. 3, the unmanned aerial vehicle control method includes the following processes.

At 301, update data of a flight restriction database returned by the server 200 in response to an updating request is received, where the updating request carries current position information of the unmanned aerial vehicle 100.

The updating request may be sent by the terminal 300 or by the unmanned aerial vehicle 100 to the server 200. For example, in some embodiments, the updating request is sent by the terminal 300 to the server 200. In some embodiments, the process at 301 specifically includes receiving the update data of the flight restriction database returned by the server 200 through the terminal 300 in response to the updating request. In some embodiments, the terminal 300 does not determine the validity of the update data of the flight restriction database sent by the server 200 to the terminal 300, but directly forwards the update data of the flight restriction database sent by the server 200 to the terminal 300 to the unmanned aerial vehicle 100. The validity of the update data of the flight restriction database is determined by the unmanned aerial vehicle 100, thereby improving the safety of the flight of the unmanned aerial vehicle 100.

In some embodiments, the updating request is directly sent by the unmanned aerial vehicle 100 to the server 200, and the server 200 directly sends the update data of the flight restriction database to the unmanned aerial vehicle 100.

In some embodiments, after receiving the updating request, the server 200 parses out current position information of the unmanned aerial vehicle 100 from the updating request. Then the server 200 directly sends the latest flight restriction database in the server 200 to the unmanned aerial vehicle 100 according to the current position information of the unmanned aerial vehicle 100, or selects the update data of the flight restriction database of the unmanned aerial vehicle 100 corresponding to the current position information from the dynamic update database of the server 200, and sends to the unmanned aerial vehicle 100, so that the unmanned aerial vehicle 100 obtains the flight restriction data around the current position to ensure the safety of the flight of the unmanned aerial vehicle 100.

In some embodiments, the server 200 can directly send the update data of the flight restriction database to the unmanned aerial vehicle 100, or transparently transmit the update data of the flight restriction database to the unmanned aerial vehicle 100 through the terminal 300. The transmission method of the update data of the flight restriction database can be determined according to a connection status of the unmanned aerial vehicle 100. For example, when the unmanned aerial vehicle 100 is in an online status, the server 200 directly sends the update data of the flight restriction database to the unmanned aerial vehicle 100; while when the unmanned aerial vehicle 100 is in an offline status, the server 200 transparently transmits the update data of the flight restriction database to the unmanned aerial vehicle 100 through the terminal 300.

In some embodiments, the flight restriction database of the unmanned aerial vehicle 100 has saved the flight restriction data, and the update data of the flight restriction database of the unmanned aerial vehicle 100 is configured to replace the saved flight restriction data of the flight restriction database of the unmanned aerial vehicle 100. In some other examples, the flight restriction database of the unmanned aerial vehicle 100 does not have any data information, and the update data of the flight restriction database of the unmanned aerial vehicle is directly saved to the flight restriction database.

In some embodiments, the flight restriction database is a dynamic flight restriction database.

In some embodiments, the flight restriction database does not distinguish between a dynamic flight restriction database and a static flight restriction database. The flight restriction database may include both a dynamic flight restriction database and a static flight restriction database.

Examples in which the flight restriction database is a dynamic flight restriction database will be described below.

In some embodiments, the update data of a dynamic data obtained at 301 is information of all temporary flight restriction region in a relatively large area, e.g., information of all temporary flight restriction regions in a country where a current position of an unmanned aerial vehicle 100 is located, information of all temporary flight restriction regions in a state (province) where a current position of an unmanned aerial vehicle 100 is located, or information of all temporary flight restriction regions within 20 km from a current position of an unmanned aerial vehicle 100 is located, etc.

In some embodiments, the update data of the flight restriction database includes at least one range information of the temporary flight restriction region and a period of validity (valid period). The range information of the temporary flight restriction region is a parameter for determining the flight restriction range of the temporary flight restriction region. In some embodiments, the range information of the temporary flight restriction region may be edge information of the temporary flight restriction region. In some embodiments, the range information of the temporary flight restriction region may be a center position and a radius of the temporary flight restriction region. The range information of the temporary flight restriction region can further be other parameters that can determine the flight restriction range of the temporary flight restriction region. Specifically, an expression form of the range information of the temporary flight restriction region can be selected according to a shape of the temporary flight restriction region. For example, the temporary flight restriction region is a regular circle, and the range information of the circular temporary flight restriction region can be expressed by the edge information of the temporary flight restriction region or the center position and the radius of the temporary flight restriction region. For another example, if the temporary flight restriction region is irregular in shape, the range information of the irregular temporary flight restriction region may be expressed by the edge information of the temporary flight restriction region. The period of validity of the temporary flight restriction region includes a start time and an end time. For the dynamic flight restriction database in the current unmanned aerial vehicle 100, the temporary flight restriction region takes effect in the period between the start time and the end time, and the unmanned aerial vehicle 100 is prohibited from flying in the temporary flight restriction region. Before the start time or after the end time, the temporary flight restriction region is invalid, and the unmanned aerial vehicle 100 can fly in the temporary flight restriction region.

The updating request carrying the current position information of the unmanned aerial vehicle 100 is sent to the server 200 through the unmanned aerial vehicle 100 or the terminal 300, and the flight restriction data of the flight restriction region in the area where the current position of the unmanned aerial vehicle 100 is located is obtained from the server 200 in time, so as to improve the accuracy and timeliness of the flight restriction data of the temporary flight restriction region. Further, determining the update data of the flight restriction database of the unmanned aerial vehicle 100 according to the position information can also prevent the amount of the requested update data of the flight restriction database of the unmanned aerial vehicle 100 being too large.

The current position information of the unmanned aerial vehicle 100 can be obtained by a GPS device on the unmanned aerial vehicle 100 or by positioning of the terminal 300. In some embodiments, the position information may be latitude and longitude but is not limited to this. In other embodiments, the position information may be other parameters that can represent the position, e.g., administrative area information.

At 302, when the update data of the flight restriction database is determined to satisfy a specific condition, the flight of the unmanned aerial vehicle 100 is controlled according to the update data of the flight restriction database.

In some embodiments, validity determination of the flight restriction database is completed by the unmanned aerial vehicle 100, and even if the flight restriction database of the unmanned aerial vehicle is not updated in time, the unmanned aerial vehicle 100 may still control the flight of the unmanned aerial vehicle 100 according to the validity of the temporary flight restriction region in the previously saved flight restriction database, thereby ensuring the safety of the unmanned aerial vehicle 100.

Various methods can be used for determining the validity of the flight restriction database. For example, in some embodiments, determining that the update data of the flight restriction database satisfies a specific condition may include obtaining real-time position information of the unmanned aerial vehicle 100; obtaining flight restriction regions within a specific range from the real-time position of the unmanned aerial vehicle 100 according to the real-time position information and the update data of the flight restriction database (the flight restriction region of a dynamic flight restriction database is a temporary flight restriction region), and determining that a current time is within the period of validity of at least one of the flight restriction regions. In some embodiments, according to the real-time position information of the unmanned aerial vehicle 100, all temporary flight restriction region information in a relatively large area obtained at 301 is further filtered to determine the flight restriction data of the temporary flight restriction regions in s relatively small area where the real-time position of the unmanned aerial vehicle 100 is located, e.g., all temporary flight restriction regions within 20 m from the real-time position of the unmanned aerial vehicle 100, and hence improving the accuracy of the flight restriction data in the temporary flight restriction region. Further, the real-time temporary flight restriction regions in effect are selected according to the validity of all the temporary flight restriction regions in the relatively small area determined by the unmanned aerial vehicle 100, and then the flight of the unmanned aerial vehicle 100 is controlled according to the real-time temporary flight restriction regions in effect, to ensure the safety of the flight of the unmanned aerial vehicle 100.

In some embodiments, determining that the update data of the flight restriction database satisfies a specific condition includes successfully verifying a signature of the update data of the flight restriction database. In some embodiments, the update data of the flight restriction database is an encrypted data. Further, determining that the update data of the flight restriction database satisfies a specific condition includes decrypting the update data of the flight restriction database according to a preset rule, where the decryption is successful, thereby preventing the data from being tampered and improving the security of the data. A complete verification process may include the following. The server 200 performs a special process on the update data of the flight restriction database to be sent and generates a “fingerprint” of the piece of data. After receiving the specially processed update data of the flight restriction database sent by the server 200, the unmanned aerial vehicle 100 also performs the same process to generate another “fingerprint.” The unmanned aerial vehicle 100 compares the “fingerprint” generated by itself with the “fingerprint” generated by the server 200. If the comparison result is consistent, it is indicated that the update data of the current flight restriction database is sent by a legal server 200. In general, the special process requires a set of passwords and a set of algorithms. An illegal server 200 can only forge update data of the flight restriction database according to the passwords and algorithms, thereby preventing the data from being tampered and improving the security of the data.

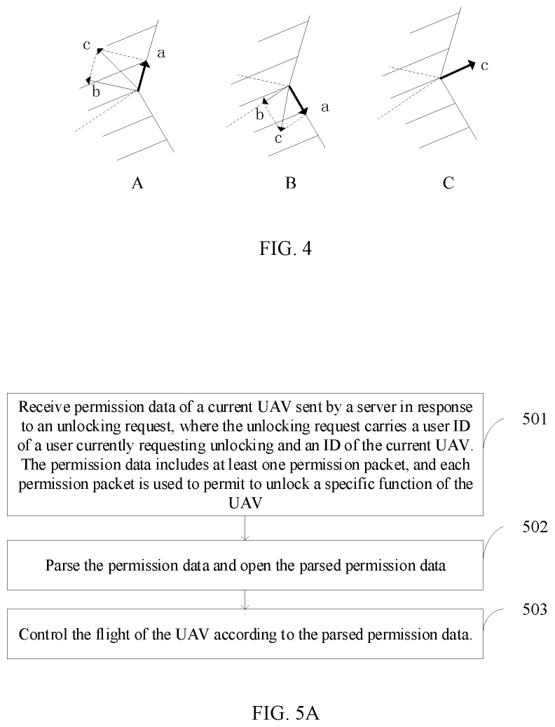

Further, after the process at 301 is executed, the method further includes saving the update data of the flight restriction database to the flight restriction database by overwriting corresponding existing data in the flight restriction database, thereby avoiding the problem of insufficient memory of the unmanned aerial vehicle 100 due to an excessive amount of data. In some embodiments, after receiving the update data of the flight restriction database, the unmanned aerial vehicle 100 replaces the flight restriction data saved in the flight restriction database of the unmanned aerial vehicle 100 with the update data received currently. This overwriting method ensures that the unmanned aerial vehicle 100 has enough memory, and hence avoiding the amount of data of the flight restriction database of the unmanned aerial vehicle 100 from becoming too large. In some embodiments, the flight restriction database of the unmanned aerial vehicle 100 does not have any data information saved in there, in which case after receiving the update data of the flight restriction database, the unmanned aerial vehicle 100 directly saves the received update data of the flight restriction database to the flight restriction database of the unmanned aerial vehicle 100. In some embodiments, after successfully verifying a signature of the update data of the flight restriction database, the unmanned aerial vehicle saves the update data of the flight restriction database to the flight restriction database by overwriting the corresponding existing data in the flight restriction database. During a takeoff or flight, the unmanned aerial vehicle 100 finds flight restriction regions within a specific range from the current position from the currently saved flight restriction database, calculates a positional relationship between the current position and each flight restriction region within the period of validity, and then control the flight of the unmanned aerial vehicle 100 according to the positional relationship. A control process is shown in FIG. 4.

At the side of the unmanned aerial vehicle 100, the method for updating the flight restriction data may further include sending version information of a current static flight restriction database to the server 200, thereby ensuring that the unmanned aerial vehicle 100 can obtain relatively accurate information of a fixed flight restriction region (e.g., information of a range of the fixed flight restriction region) in time, which in turn enables the unmanned aerial vehicle 100 to obtain the relatively accurate information of the fixed flight restriction region. In some embodiments, the unmanned aerial vehicle 100 actively informs the server 200 of the version information of the current static flight restriction database of the unmanned aerial vehicle 100, and the server 200 further determines whether to update the current static flight restriction database of the unmanned aerial vehicle 100. In some embodiments, the version information may include a version number of the current static flight restriction database, and the server 200 determines whether to update the current static flight restriction database of the unmanned aerial vehicle 100 according to the version number of the current static flight restriction database. In some embodiments, the version information may include an update time of the current static flight restriction database, and the server 200 determines whether to update the current static flight restriction database of the unmanned aerial vehicle 100 according to the update time of the current static flight restriction database.

In some embodiments, when the version information of the current static flight restriction database of the unmanned aerial vehicle 100 is different from the version information of the static flight restriction database of the server 200, the server 200 sends the update data of the static flight restriction database of the unmanned aerial vehicle 100 (e.g., all data in the static flight restriction database of the server 200) to the unmanned aerial vehicle 100, to update the current static flight restriction database of the unmanned aerial vehicle 100. At the side of the unmanned aerial vehicle 100, the method for updating the flight restriction data may further include receiving the update data of the static flight restriction database sent by the server 200, and updating the static flight restriction database according to the update data of the static flight restriction database, to realize the update of the static flight restriction database of the unmanned aerial vehicle 100, so that the unmanned aerial vehicle 100 can obtain relatively accurate information of the fixed flight restriction region.

As shown in FIG. 4, during takeoff or flight, when the unmanned aerial vehicle 100 is on the edge of the valid flight restriction region or in a buffer area on the edge of the valid flight restriction region, the process for controlling the flight of the unmanned aerial vehicle 100 includes receiving a velocity instruction sent by the terminal 300, decomposing the velocity instruction, and determining the direction of the velocity (velocity direction). If the velocity direction is toward the inside of the current flight restriction region (e.g., velocity c in part A of FIG. 4 and velocity c in part B of FIG. 4), a component of the velocity parallel to the edge of the flight restriction region (e.g., velocity a in part A of FIG. 4 and velocity a in part B of FIG. 4) is selected to control the flight of the unmanned aerial vehicle 100, and hence preventing the unmanned aerial vehicle 100 from entering the current flight restriction region. If the velocity direction does not point to the inside of the current flight restriction region, the unmanned aerial vehicle 100 is controlled to fly at the velocity indicated by the velocity instruction (e.g., velocity c in part C of FIG. 4).

Further, the unmanned aerial vehicle system also provides a method to unlock a specific function of the unmanned aerial vehicle 100, e.g., a flight restriction function, a specific route mode, a specific flight mode, a specific photographing function of a camera disposed on the unmanned aerial vehicle 100, etc.

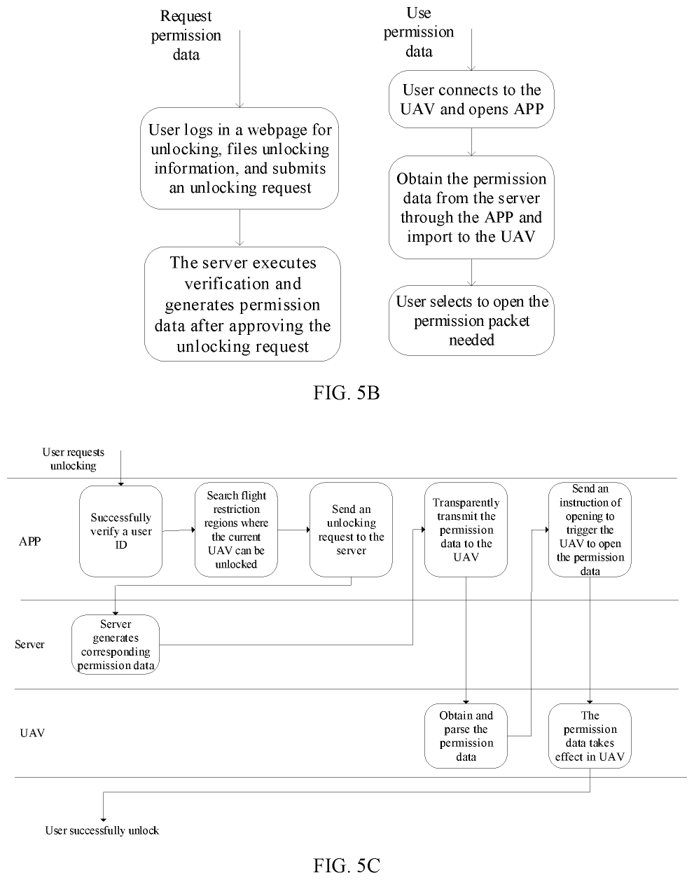

In some embodiments, as shown in FIG. 5A, the unmanned aerial vehicle control method further includes the following processes.

At 501, permission data of the current unmanned aerial vehicle 100 sent by the server 200 in response to an unlocking request is received, where the unlocking request carries a user ID of a user currently requesting and an ID of the current unmanned aerial vehicle 100. The permission data includes at least one permission packet, and each permission packet is used to permit to unlock a specific function of the unmanned aerial vehicle 100.

The unlocking request can be raised by the user on the terminal 300 or on a webpage and sent to the server 200, or sent by the unmanned aerial vehicle 100 to the server 200. For example, in some embodiments, the unlocking request is sent by the terminal 300 to the server 200. The process at 501 specifically includes receiving the permission data of the current unmanned aerial vehicle 100 sent by the server 200 through the terminal 300 in response to the unlocking request. In some embodiments, the terminal 300 directly forwards the permission data sent by the server 200 to the terminal 300 to the unmanned aerial vehicle 100. The user selects and validates one or more permission packets in the permission data through an interactive interface provided on the terminal 300 or other devices to unlock the required specific functions of the unmanned aerial vehicle 100, which has high versatility. In some embodiments, the terminal 300 performs a signature verification on the permission data sent by the server 200 to the terminal 300, and sends the permission data to the unmanned aerial vehicle 100 after the verification is successful. The method for the terminal to perform the signature verification on the permission data is similar to the method of the signature verification on the received update data of the flight restriction database by the unmanned aerial vehicle 100 in the embodiment described above, and will not be repeated here.

In some embodiments, the unlocking request is directly sent by the unmanned aerial vehicle 100 to the server 200. The server 200 generates the permission data of the current unmanned aerial vehicle 100 in response to the unlocking request and directly sends the permission data to the unmanned aerial vehicle 100.

After receiving the unlocking request, the server 200 generates the corresponding permission data according to the user ID of the user currently requesting and the ID of the current unmanned aerial vehicle 100. In some embodiments, two unmanned aerial vehicles 100, unmanned aerial vehicle A and unmanned aerial vehicle B, are shared by two users, user 1 and user 2. Table 1 shows permission data generated by the server 200 in response to different unlocking requests. As shown in Table 1, when user 1 sends an unlocking request to the server 200 corresponding to unmanned aerial vehicle A, the server 200 generates permission data A1 corresponding to user 1 and unmanned aerial vehicle A after receiving the unlocking request. When user 1 sends an unlocking request to the server 200 corresponding to unmanned aerial vehicle B, the server 200 generates permission data B1 corresponding to user 1 and unmanned aerial vehicle B after receiving the unlocking request. When user 2 sends an unlocking request to the server 200 corresponding to unmanned aerial vehicle A, the server 200 generates permission data A2 corresponding to user 2 and unmanned aerial vehicle A after receiving the unlocking request. When user 2 sends an unlocking request to the server 200 corresponding to unmanned aerial vehicle B, the server 200 generates permission data B2 corresponding to user 1 and unmanned aerial vehicle B after receiving the unlocking request.

TABLE 1

| | Unmanned aerial vehicle A | Unmanned aerial vehicle B |
|---|---|---|
| User 1 | Permission data A1 | Permission data B1 |
| User 2 | Permission data A2 | Permission data B2 |

In some embodiments, the permission data may include at least one permission packet, and each permission packet is used to permit a specific user to unlock a specific function. For example, the permission packet in permission data A1 can only be used by user 1 to execute unlocking. In some embodiments, the permission data may include at least one permission packet, and each permission packet is used to permit more than one specific user to unlock a specific function. In some embodiments, the permission data may include at least one permission packet, and each permission packet is used to permit a user to unlock more than one function. In some embodiments, the permission data may include at least one permission packet, and each permission packet is used to permit more than one user to unlock more than one function.

In some embodiments, the permission data may further include a period of validity corresponding to each permission packet. Only within the period of validity of the current permission packet, a specific function corresponding to the permission packet in the unmanned aerial vehicle 100 can be unlocked.

In some embodiments, the permission data may further include the number of permission packets included and/or the ID of the specific user. By adding the number of permission packets and/or the ID of the specific user to the permission data, it is convenient for the unmanned aerial vehicle 100 to verify the validity of the permission data, thereby preventing illegal tampering.

In some embodiments, the permission data may include at least one permission packet, and each permission packet is used to permit a specific user to unlock a specific function of a specific unmanned aerial vehicle 100. The permission packet may further include the ID of the specific unmanned aerial vehicle 100. For example, a permission packet A11 in the permission data A1 can only be used by user 1 to unlock function 1 of unmanned aerial vehicle A.

In some embodiments, the method for unlocking a specific function of the unmanned aerial vehicle 100 is shown in FIG. 5B, where one method includes permission data application by the user and using by the user. In the permission data application process, the user submits information required for unlocking and prepares an unlocking request through a webpage. After the unlocking request is approved, the server 200 generates the permission data. In the permission data using process, the user can download the permission data from the server 200 through the terminal and import the permission data into the unmanned aerial vehicle 100. When the user needs to use the function of unlocking, the user can choose to open the permission packet corresponding to the function of unlocking.

In some embodiments, another method for unlocking a specific function of the unmanned aerial vehicle 100 is self-unlocking, as shown in FIG. 5C. User information is stored in the terminal, where the user information can be bank card information of the user (e.g., credit card information), identity information (e.g., ID card information or other information that can identify the identity of the user), mobile phone information, information registered by the user in a verification system, or other information that can identify the user. The terminal can use the stored information of the user to request to unlock a specific function of the unmanned aerial vehicle 100 without a need for the user to fill in the information required for unlocking. The user only needs to file an unlocking request. The terminal acquires the information of the user and other information required for unlocking according to the unlocking request, and automatically generates the unlocking request and send the request to the server. The unlocking method in some embodiments is more complicated than the unlocking method described above since the terminal 300 automatically helps the user to complete many processes that the user needs to operate in the method described above. For example, when the terminal acquires other information required for unlocking, specifically, the terminal 300 searches current flight restriction regions where the unmanned aerial vehicle 100 can be unlocked, transparently transmits the permission data to the unmanned aerial vehicle 100, and sends an instruction of opening (opening instruction) to trigger the unmanned aerial vehicle 100 to open the permission data, etc. Through the series of operations, the legality and security of the self-unlocking can be improved.

In some embodiments, the self-unlocking function is used to unlock a specific flight restriction function of the unmanned aerial vehicle 100. The permission data may be used to instruct the unmanned aerial vehicle 100 to realize at least one of the functions including lifting the flight restriction of the unmanned aerial vehicle 100 within a specific flight restriction region, lifting the flight restriction of the unmanned aerial vehicle 100 within all flight restriction regions in a specific country, controlling the unmanned aerial vehicle 100 to fly only in a specific flight restriction region, and lifting an altitude restriction of the unmanned aerial vehicle 100 during flight. When the permission data is used to instruct the unmanned aerial vehicle 100 to realize the function of controlling the unmanned aerial vehicle 100 to fly only in a specific flight restriction region, the permission data includes information of a flight altitude of the unmanned aerial vehicle 100 and edge information of the region, that is, the unmanned aerial vehicle 100 is controlled to fly only at a specific altitude within a specific region. For example, a maximum flight altitude of the unmanned aerial vehicle 100 in the specific region is 50 m. It should be noted that unlocking a specific flight restriction function of the unmanned aerial vehicle 100 is not limited to the methods described above.

Further, when the self-unlocking function is used to unlock a specific flight restriction function of the unmanned aerial vehicle 100, before the terminal 300 sends the unlocking request to the server 200, it is needed to determine flight restriction regions that allow to lift the flight restriction corresponding to the current position of the unmanned aerial vehicle 100. The terminal 300 then sends the unlocking request to the server 200 according to the flight restriction regions that allow to lift the flight restriction, to ensure that the current unlocked specific flight restriction function of the unmanned aerial vehicle 100 is legal. The process of the terminal 300 determining flight restriction regions that allow to lift the flight restriction corresponding to the current position of the unmanned aerial vehicle 100 is as follows. The terminal 300 acquires real-time position information of the unmanned aerial vehicle 100, and acquires flight restriction regions within a specific range from the real-time position of the unmanned aerial vehicle 100 according to the real-time position information and the flight restriction database of the current unmanned aerial vehicle 100. At this point, the terminal 300 can obtain the flight restriction regions near the current position of the unmanned aerial vehicle 100 (within a specific range from the real-time position of the unmanned aerial vehicle 100). Further, the terminal 300 determines flight restriction regions that allow to lift the flight restriction from the obtained flight restriction regions according to a preset strategy. For example, in some embodiments, the terminal 300 may determine flight restriction regions that allow to lift the flight restriction from the obtained flight restriction regions according to security levels of the flight restriction regions. Specifically, a flight restriction region with a security level lower than a preset level is selected from the obtained flight restriction regions as the flight restriction region that allows to lift the flight restriction. In some embodiments, the terminal 300 may determine flight restriction regions that allow to lift the flight restriction from the obtained flight restriction regions according to area information where the current position of the unmanned aerial vehicle 100 is located. For example, when the area where the current position of the unmanned aerial vehicle 100 is located is a specific area, a specific model of the unmanned aerial vehicle 100 may be allowed to lift the flight restriction in the specific area, or an unmanned aerial vehicle 100 controlled by a specific user may be allowed to lift the flight restriction in the specific area. In some embodiments, the terminal 300 may determine flight restriction regions that allow to lift the flight restriction from the obtained flight restriction regions according to the ID of the unmanned aerial vehicle 100, which in turn determines flight restriction regions that allow to lift the flight restriction according to a grade of unmanned aerial vehicle 100. In some embodiments, the terminal 300 may determine flight restriction regions that allow to lift the flight restriction from the obtained flight restriction regions according to the ID of the user currently logged in, which in turn determines flight restriction regions that allow to lift the flight restriction according to the information of the user currently logged in. In some embodiments, the terminal 300 may determine flight restriction regions that allow to lift the flight restriction from the obtained flight restriction regions according to a management authority of the user currently logged in, which in turn determines flight restriction regions that allow to lift the flight restriction according to the authority of the user currently logged in. After determining the flight restriction regions that allow to lift the flight restriction corresponding to the current position of the unmanned aerial vehicle 100, the terminal 300 generates the unlocking request according to the flight restriction regions that allow to lift the flight restriction and sends the request to the server 200, and then obtains corresponding permission data from the server 200.

The transmission method of the permission data sent by the server 200 to the unmanned aerial vehicle 100 can be determined according to a connection status of the unmanned aerial vehicle 100. For example, when the unmanned aerial vehicle 100 is in an online status, the server 200 directly sends the permission data to the unmanned aerial vehicle 100; while when the unmanned aerial vehicle 100 is in an offline status, the server 200 transparently transmits the permission data to the unmanned aerial vehicle 100 through the terminal 300.

Further, in some embodiments, the server directly sends the permission data to the unmanned aerial vehicle 100 after receiving the unlocking request and generating the permission data.

In some embodiments, the server sends the permission data to the unmanned aerial vehicle 100 after receiving the unlocking request, generating the permission data, and receiving a importing request. The importing request carries the user ID of the user currently requesting and the ID of the unmanned aerial vehicle 100 to be imported with the permission data. The server 200 obtains the corresponding permission data according to the user ID and the ID of the unmanned aerial vehicle 100, and then sends the obtained permission data to the unmanned aerial vehicle 100. The importing request can be sent by the terminal 300 or the unmanned aerial vehicle 100 to the server 200.

At 502, the permission data is parsed and the parsed permission data is opened.

At 502, after the unmanned aerial vehicle 100 parses the permission data, the permission packet in the permission data does not take effect in real time. The unmanned aerial vehicle 100 needs to further open the parsed permission data to make at least part of the permission packet in the permission data effective. The method for the unmanned aerial vehicle 100 to parse the permission data is determined according to the permission data received by the unmanned aerial vehicle 100. For example, in some embodiments, the permission data received by the unmanned aerial vehicle 100 is encrypted by the server 200, and the unmanned aerial vehicle 100 needs to decrypt the received permission data to read the data after receiving the encrypted permission data.

Further, in some embodiments, the unmanned aerial vehicle 100 opening the parsed permission data is triggered by the terminal 300. The permission data can be selected to be opened according to the need of the user, which has high flexibility. Specifically, before the unmanned aerial vehicle 100 opens the parsed permission data, the method may further include receiving an instruction of opening sent by the terminal 300 indicating the permission data takes effect. For example, the instruction of opening can be used to instruct all the permission packets in the permission data to take effect, or to instruct a part of the permission packets in the permission data to take effect. After receiving the instruction of opening, the unmanned aerial vehicle 100 selects the corresponding permission packet to take effect according to the instruction of opening, and a specific function corresponding to the permission packet in effective takes effect in the unmanned aerial vehicle 100.

In some embodiments, the instruction of opening carries the ID of the user currently managing the unmanned aerial vehicle 100. Before opening the parsed permission data, the unmanned aerial vehicle 100 needs to further analyze the instruction of opening and the permission data, to ensure the legality of the unlocking. For example, in some embodiments, the unmanned aerial vehicle 100 determines that an ID of a user corresponding to the permission data is the same as the ID of the user in the instruction of opening, and then opens the parsed permission data so that the permission packet corresponding to the parsed permission data takes effect. In some embodiments, the unmanned aerial vehicle 100 determines that a management authority of a user corresponding to the ID of the user in the instruction of opening is a preset authority, and then opens the parsed permission data so that the permission packet corresponding to the parsed permission data takes effect. The preset authority can be an administrator authority or a captain authority.

Further, after opening the parsed permission data, the unmanned aerial vehicle 100 can also be triggered by the terminal 300 to close the opened permission data, so as to disable a specific function that is unlocked but not needed by the unmanned aerial vehicle 100 in time, and hence improving the safety of the flight of the unmanned aerial vehicle 100. Specifically, after the unmanned aerial vehicle 100 opens the parsed permission data, the method may further include receiving an instruction of closing (closing instruction) sent by the terminal 300 indicating the permission data becomes invalid, and closing the opened permission data.

In some embodiments, the instruction of closing carries the ID of the user currently controlling the unmanned aerial vehicle 100, and before the unmanned aerial vehicle 100 closes the opened permission data, the method may further include determining that the ID of the user corresponding to the permission data is the same as the ID of the user in the instruction of closing, to ensure the legality of the operation of disabling the unlocked specific function of the unmanned aerial vehicle 100, thereby further improving the safety of the flight of the unmanned aerial vehicle 100.

At 503, the flight of the unmanned aerial vehicle 100 is controlled according to the parsed permission data.

In some embodiments, the parsing and opening of the permission data is completed by the unmanned aerial vehicle 100, and the user may unlock the specific function of the unmanned aerial vehicle 100 according to need, which has high flexibility.

When the permission data includes a period of validity corresponding to each permission packet, the process at 503 may specifically include determining that a permission packet is in effect based on the period of validity of the permission packet. In some embodiments, the unmanned aerial vehicle 100 controls the flight of the unmanned aerial vehicle 100 according to the permission in effect, and improves the safety of the flight of the unmanned aerial vehicle 100.

When the self-unlocking function is used to unlock the specific flight restriction function of the unmanned aerial vehicle 100, the process at 503 may specifically include controlling the flight of the unmanned aerial vehicle 100 according to the parsed permission data and the current flight restriction database of the unmanned aerial vehicle 100, improving the safety of the flight of the unmanned aerial vehicle 100, and meeting a specific need of the user. In some embodiments, the flight restriction database may be a dynamic flight restriction database. In some embodiments, the flight restriction database may be a dynamic flight restriction database and a static flight restriction database.

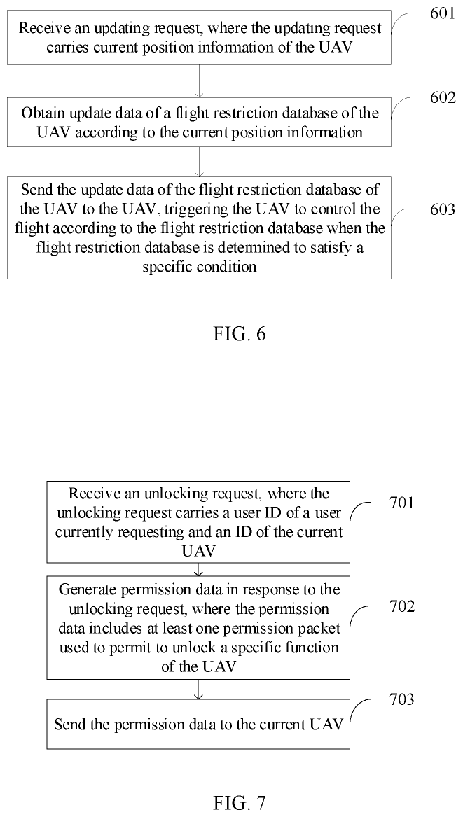

In another embodiment, there is provided an unmanned aerial vehicle control method. FIG. 6 is the flowchart of the method for controlling the unmanned aerial vehicle. The method can be implemented by, e.g., the server 200.

As shown in FIG. 6, the unmanned aerial vehicle control method includes the following processes.

At 601, an updating request is received, where the updating request carries current position information of the unmanned aerial vehicle 100.

The updating request may be sent by the terminal 300 or by the unmanned aerial vehicle 100 to the server 200. For example, in some embodiments, the updating request is sent by the terminal 300 to the server 200.

The current position information of the unmanned aerial vehicle 100 can be obtained by a GPS device on the unmanned aerial vehicle 100 or by positioning of the terminal 300. In some embodiments, the position information may be latitude and longitude but is not limited to this. In other embodiments, the position information may be other parameters that can represent the position, e.g., administrative area information.

At 602, update data of a flight restriction database of the unmanned aerial vehicle 100 is acquired according to the current position information.

After receiving the updating request, the server 200 parses out current position information of the unmanned aerial vehicle 100 from the updating request. Then the server 200 directly sends the latest flight restriction database in the server 200 to the unmanned aerial vehicle 100 according to the current position information of the unmanned aerial vehicle 100, or selects the update data of the flight restriction database of the unmanned aerial vehicle 100 corresponding to the current position information from the dynamic update database of the server 200. The process at 602 specifically includes obtaining the update data of the flight restriction database according to a preset generation strategy based on the current position information, so as to obtain the update data of the flight restriction database of the unmanned aerial vehicle 100 according to an actual need.

In some embodiments, the flight restriction database is a dynamic flight restriction database.

In some embodiments, the flight restriction database does not distinguish between a dynamic flight restriction database and a static flight restriction database. The flight restriction database may include both a dynamic flight restriction database and a static flight restriction database.

The following embodiment will be described by taking the flight restriction database as a dynamic flight restriction database as an example.

In a specific implementation method, obtaining the update data of the flight restriction database according to a preset generation strategy based on the current position information may include obtaining country information of the area where the current position of the unmanned aerial vehicle 100 is located according to the current position information and obtaining the update data of the flight restriction database according to the country information. For example, if the current area of the unmanned aerial vehicle 100 is a specific country, the update data of the flight restriction database can be acquired according to an update frequency of a temporary flight restriction region in the specific country. When the update frequency of the temporary flight restriction region in the specific country is greater than a preset frequency value, the update data of the flight restriction database acquired by the server 200 may include information of all temporary flight restriction regions within a range of 20 km from the current position of the unmanned aerial vehicle 100. When the update frequency of the temporary flight restriction region in the specific country is less than or equal to the preset frequency value, the update data of the flight restriction database acquired by the server 200 may include information of all temporary flight restriction regions in the specific country. This is because in an area where the temporary flight restriction region is updated relatively fast, the area information in the flight restriction database in the server 200 is also updated relatively fast, and the dynamic flight restriction database in the unmanned aerial vehicle 100 is also updated relatively fast, in which case obtaining information of all the temporary flight restriction regions will cause the amount of data transmitted by the unmanned aerial vehicle 100 to be too large. On the other hand, in an area where the temporary flight restriction region is updated relatively slowly, the area information in the flight restriction database in the server 200 is also updated relatively slowly, and the dynamic flight restriction database in the unmanned aerial vehicle 100 is also updated relatively slowly, in which case information of all the temporary flight restriction regions in this area can be acquired to ensure the safety of the flight of the unmanned aerial vehicle 100.

In some embodiments, the update data of the flight restriction database includes at least one range information of the temporary flight restriction region and a period of validity. The range information of the temporary flight restriction region is a parameter for determining the flight restriction range of the temporary flight restriction region. In some embodiments, the range information of the temporary flight restriction region may be edge information of the temporary flight restriction region. In some embodiments, the range information of the temporary flight restriction region may be a center position and a radius of the temporary flight restriction region. The range information of the temporary flight restriction region can further be other parameters that can determine the flight restriction range of the temporary flight restriction region. Specifically, an expression form of the range information of the temporary flight restriction region can be selected according to a shape of the temporary flight restriction region. For example, the temporary flight restriction region is a regular circle, and the range information of the circular temporary flight restriction region can be expressed by the edge information of the temporary flight restriction region or the center position and the radius of the temporary flight restriction region. For another example, if the temporary flight restriction region is irregular in shape, the range information of the irregular temporary flight restriction region may be expressed by the edge information of the temporary flight restriction region. The period of validity of the temporary flight restriction region includes a start time and an end time. For the dynamic flight restriction database in the current unmanned aerial vehicle 100, the temporary flight restriction region takes effect in the period between the start time and the end time, and the unmanned aerial vehicle 100 is prohibited from flying in the temporary flight restriction region. Before the start time or after the end time, the temporary flight restriction region is invalid, and the unmanned aerial vehicle 100 can fly in the temporary flight restriction region.

The updating request carrying the current position information of the unmanned aerial vehicle 100 is sent to the server 200 through the unmanned aerial vehicle 100 or the terminal 300, and the flight restriction data of the flight restriction region in the area where the current position of the unmanned aerial vehicle 100 is located is obtained from the server 200 in time, so as to improve the accuracy and timeliness of the flight restriction data of the temporary flight restriction region. Further, determining the update data of the flight restriction database of the unmanned aerial vehicle 100 according to the position information can also prevent the amount of the requested update data of the flight restriction database of the unmanned aerial vehicle 100 being too large.

In some embodiments, the update data of a dynamic data obtained in 602 is information of all temporary flight restriction region in a relatively large area, e.g., information of all temporary flight restriction regions in a country where a current position of an unmanned aerial vehicle 100 is located, information of all temporary flight restriction regions in a state (province) where a current position of an unmanned aerial vehicle 100 is located, or information of all temporary flight restriction regions within 20 km from a current position of an unmanned aerial vehicle 100 is located, etc.

At 603, the update data of the flight restriction database of the unmanned aerial vehicle 100 is sent to the unmanned aerial vehicle 100, triggering the unmanned aerial vehicle 100 to control the flight according to the flight restriction database when the flight restriction database is determined to satisfy a specific condition.

In some embodiments, validity determination of the flight restriction database is completed by the unmanned aerial vehicle 100, and even if the flight restriction database of the unmanned aerial vehicle is not updated in time, the unmanned aerial vehicle 100 may still control the flight of the unmanned aerial vehicle 100 according to the validity of the temporary flight restriction region in the previously saved flight restriction database, thereby ensuring the safety of the unmanned aerial vehicle 100.

In some embodiments, the updating request is sent by the terminal 300 to the server 200. 603 may include sending the update data of the flight restriction database of the unmanned aerial vehicle 100 to the terminal 300, and the terminal 300 transparently transmits the flight restriction database to the unmanned aerial vehicle 100. In some embodiments, the terminal 300 does not determine the validity of the update data of the flight restriction database sent by the server 200 to the terminal 300, but directly forwards the update data of the flight restriction database sent by the server 200 to the terminal 300 to the unmanned aerial vehicle 100. Then the validity of the update data of the flight restriction database is determined by the unmanned aerial vehicle 100, thereby improving the safety of the flight of the unmanned aerial vehicle 100.

In some embodiments, the updating request is directly sent by the unmanned aerial vehicle 100 to the server 200, and the server 200 directly sends the update data of the flight restriction database to the unmanned aerial vehicle 100.

After the process at 602, the method may further include adding a signature to the update data of the flight restriction database of the unmanned aerial vehicle 100. The process at 603 may include sending a signature-added update data of the flight restriction database of the unmanned aerial vehicle 100. The unmanned aerial vehicle 100 needs to verify the signature to open the update data of the flight restriction database to ensure the legality of the update data of the flight restriction database. Specifically, in some embodiments, after the process at 602, the method may further include encrypting the update data of the flight restriction database according to a preset rule. The process at 603 may include sending the encrypted update data of the flight restriction database to the unmanned aerial vehicle 100. A complete verification process may include the following. The server 200 performs a special process on the update data of the flight restriction database to be sent and generates a “fingerprint” of the piece of data. After receiving the specially processed update data of the flight restriction database sent by the server 200, the unmanned aerial vehicle 100 also performs the same process to generate another “fingerprint.” The unmanned aerial vehicle 100 compares the “fingerprint” generated by itself with the “fingerprint” generated by the server 200. If the comparison result is consistent, it is indicated that the update data of the current flight restriction database is sent by a legal server 200. In general, the special process requires a set of passwords and a set of algorithms. An illegal server 200 can only forge update data of the flight restriction database according to the passwords and algorithms, thereby preventing the data from being tampered and improving the security of the data.

Further, the method may include receiving a version information of the static flight restriction database in the unmanned aerial vehicle 100 sent by the unmanned aerial vehicle 100, so that the validity of the static flight restriction database of the unmanned aerial vehicle 100 can be determined by server 200. The server 200 may determine the validity of the static flight restriction database of the unmanned aerial vehicle 100 according to the version information of the static flight restriction database in the unmanned aerial vehicle 100, thereby determining whether to send the static flight restriction database in the server 200 to the unmanned aerial vehicle 100 to update the static flight restriction database in the unmanned aerial vehicle 100 in time.

In some embodiments, the method may further include sending the static flight restriction database in the server 200 to the unmanned aerial vehicle 100, so that the unmanned aerial vehicle 100 can update the stored static flight restriction database in time. In some embodiments, sending the static flight restriction database in the server 200 to the unmanned aerial vehicle 100 is executed when the version of the static flight restriction database in the unmanned aerial vehicle 100 is older than that of the static flight restriction database in the server 200, to ensure that the unmanned aerial vehicle 100 can obtain a latest version of the static flight restriction database in time, and hence ensuring the safety of the flight of the unmanned aerial vehicle 100. In some embodiments, sending the static flight restriction database in the server 200 to the unmanned aerial vehicle 100 is executed immediately after the static flight restriction database is in the server 200 is updated. After updating the stored static flight restriction database, the server 200 immediately sends the updated static flight restriction database to the unmanned aerial vehicle 100, so as to realize the update of the static flight restriction database of the unmanned aerial vehicle 100 in time.

Further, the unmanned aerial vehicle system also has a function of self-unlocking to unlock a specific function of the unmanned aerial vehicle 100, e.g., a flight restriction function, a specific route mode, a specific flight mode, a specific photographing function of a camera disposed on the unmanned aerial vehicle 100, etc.

As shown in FIG. 7, the method further includes the following processes.

At 701, an unlocking request is received, where the unlocking request carries a user ID of a user currently requesting and an ID of the current unmanned aerial vehicle 100.

The unlocking request can be sent by the terminal 300 to the server 200, or sent by the unmanned aerial vehicle 100 to the server 200.

At 702, permission data is generated in response to the unlocking request, where the permission data includes at least one permission packet, and each permission packet is used to permit to unlock a specific function of the unmanned aerial vehicle 100.

In some embodiments, after receiving the unlocking request, the server 200 generates the corresponding permission data according to the user ID of the user currently requesting and the ID of the current unmanned aerial vehicle 100. The description above can be referred to for details of the permission data, and will not be repeated here.

At 703, the permission data is sent to the current unmanned aerial vehicle 100.

In some embodiments, the parsing and opening of the permission data is completed by the unmanned aerial vehicle 100, and the user may unlock the specific function of the unmanned aerial vehicle 100 according to the need, which has high flexibility.

In some embodiments, the unlocking request is sent by the terminal 300 to the server 200, and the process at 703 may specifically include transparently transmitting the permission data to the unmanned aerial vehicle 100 through the terminal 300. In some embodiments, the terminal 300 does not implement any process to the permission data sent by the server 200 to the terminal 300, but directly forwards the permission data sent by the server 200 to the terminal 300 to the unmanned aerial vehicle 100. Then one or more permission packets in the permission data are opened by self-unlocking to unlock the required specific function of the unmanned aerial vehicle 100, which has high versatility.

In some embodiments, the unlocking request is directly sent by the unmanned aerial vehicle 100 to the server 200. The server 200 generates the permission data of the current unmanned aerial vehicle 100 in response to the unlocking request and directly sends the permission data to the unmanned aerial vehicle 100.

The transmission method of the permission data sent by the server 200 to the unmanned aerial vehicle 100 can be determined according to a connection status of the unmanned aerial vehicle 100. For example, when the unmanned aerial vehicle 100 is in an online status, the server 200 directly sends the permission data to the unmanned aerial vehicle 100; while when the unmanned aerial vehicle 100 is in an offline status, the server 200 transparently transmits the permission data to the unmanned aerial vehicle 100 through the terminal 300.

Further, after the server 200 executes 702 and before the server 200 executes 703, the method may further include encrypting the generated permission data. The server 200 executing 703 specifically includes sending the encrypted permission data to the current unmanned aerial vehicle 100, thereby preventing the data from being tampered and improving the security of the data.

Further, in some embodiments, the server directly sends the permission data to the unmanned aerial vehicle 100 after receiving the unlocking request and generating the permission data.

In some embodiments, the server sends the permission data to the unmanned aerial vehicle 100 after receiving the unlocking request, generating the permission data, and receiving a importing request. The importing request carries the user ID of the user currently requesting and the ID of the unmanned aerial vehicle 100 to be imported with the permission data. The server 200 obtains the corresponding permission data according to the user ID and the ID of the unmanned aerial vehicle 100, and then sends the obtained permission data to the unmanned aerial vehicle 100. The importing request can be sent by the terminal 300 or the unmanned aerial vehicle 100 to the server 200.

It should be noted that the execution process of the unmanned aerial vehicle 100 is described with reference to above embodiment, and will not be repeated here.

In another embodiment, in response to the unmanned aerial vehicle control method in above embodiments, there is provided an unmanned aerial vehicle control device that can be applied to an unmanned aerial vehicle 100.

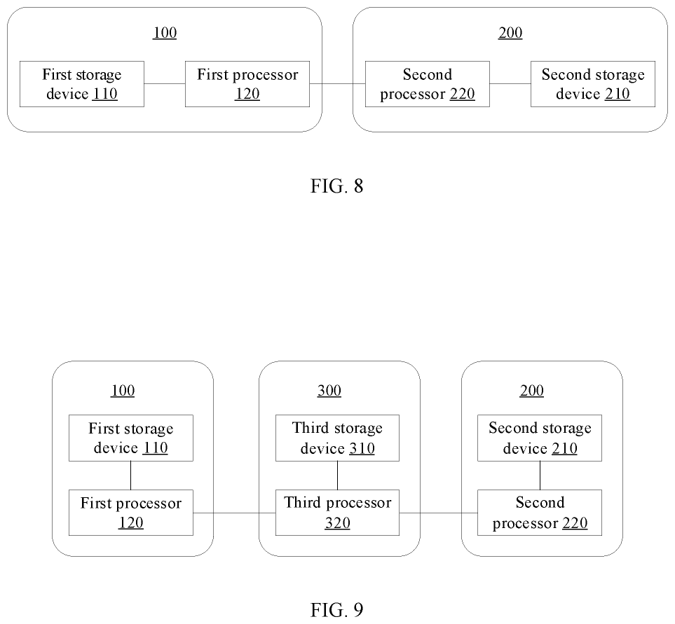

With reference to FIG. 8 and FIG. 9, there is provided an unmanned aerial vehicle control device including a first storage device 110 and a first processor 120 (e.g., a single-core or a multi-core processor).

The first storage device 110 may include a volatile memory, e.g., a random-access memory (RAM), a non-volatile memory, e.g., a flash memory, a hard disk drive (HDD)o, or a solid-state drive (SSD). The first storage device 110 may also include a combination of the above described types of memory.

The first processor 120 can be a central processing unit (CPU). The first processor 120 may further include a hardware chip that may be an application-specific integrated circuit (ASIC), a programmable logic device (PLD), or a combination thereof. The programmable logic device may be a complex programmable logic device (CPLD), a field-programmable gate array (FPGA), a generic array logic (GAL), or an any combination thereof.

In some embodiments, the first storage device 110 is configured to store a program instruction. One or more of the first processors 120 may be included, and may work individually or together. The first processor 120 calls the program instruction, and the execution of the program instruction implements the processes of the unmanned aerial vehicle control method described above.

The embodiments described above may be referred to for details of the method, and will not be repeated here.

In another embodiment, in response to the unmanned aerial vehicle control method in above embodiments, there is provided an unmanned aerial vehicle control device that can be applied to a server 200.

With reference to FIG. 8 and FIG. 9, there is provided an unmanned aerial vehicle control device including a second storage device 210 and a second processor 220 (e.g., a single-core or a multi-core processor).

The second storage device 210 may include a volatile memory, e.g., a random-access memory (RAM), a non-volatile memory, e.g., a flash memory, a hard disk drive (HDD)o, or a solid-state drive (SSD). The second storage device 210 may also include a combination of the above described types of memory.

The second processor 220 can be a central processing unit (CPU). The second processor 220 may further include a hardware chip that may be an application-specific integrated circuit (ASIC), a programmable logic device (PLD), or a combination thereof. The programmable logic device may be a complex programmable logic device (CPLD), a field-programmable gate array (FPGA), a generic array logic (GAL), or an any combination thereof.

In some embodiments, the second storage device 210 is configured to store a program instruction. One or more of the second processors 220 may be included, and may work individually or together. The second processor 220 calls the program instruction, and the execution of the program instruction implements the processes of the unmanned aerial vehicle control method described above.

The embodiments described above can be referred to for details of the method, and will not be repeated here.

In another embodiment, there is provided an unmanned aerial vehicle control method. FIG. 5A is the flowchart of the method for controlling the unmanned aerial vehicle. The method can be implemented by, e.g., the unmanned aerial vehicle 100.

In some embodiments, as shown in FIG. 5A, the unmanned aerial vehicle control method further includes the following processes.

At 501, permission data of the current unmanned aerial vehicle 100 sent by the server 200 in response to an unlocking request is received, where the unlocking request carries a user ID of a user currently requesting and an ID of the current unmanned aerial vehicle 100. The permission data includes at least one permission packet, and each permission packet is used to permit to unlock a specific function of the unmanned aerial vehicle 100.

The unlocking request can be sent by the terminal 300 to the server 200, or sent by the unmanned aerial vehicle 100 to the server 200. For example, in some embodiments, the unlocking request is sent by the terminal 300 to the server 200. The process at 501 specifically includes receiving the permission data of the current unmanned aerial vehicle 100 sent by the server 200 through the terminal 300 in response to the unlocking request. In some embodiments, the terminal 300 directly forwards the permission data sent by the server 200 to the terminal 300 to the unmanned aerial vehicle 100. Then one or more permission packets in the permission data are opened by self-unlocking to unlock the required specific function of the unmanned aerial vehicle 100, which has high versatility. In some embodiments, the terminal 300 performs a signature verification on the permission data sent by the server 200 to the terminal 300, and sends the permission data to the unmanned aerial vehicle 100 after the verification is successful.

The method for the terminal to perform the signature verification on the permission data is similar to the method of the signature verification on the received update data of the flight restriction database by the unmanned aerial vehicle 100 in the embodiment described above, and will not be repeated here.

In some embodiments, the unlocking request is directly sent by the unmanned aerial vehicle 100 to the server 200. The server 200 generates the permission data of the current unmanned aerial vehicle 100 in response to the unlocking request and directly sends the permission data to the unmanned aerial vehicle 100.

After receiving the unlocking request, the server 200 generates the corresponding permission data according to the user ID of the user currently requesting and the ID of the current unmanned aerial vehicle 100. In some embodiments, two unmanned aerial vehicles 100, unmanned aerial vehicle A and unmanned aerial vehicle B, are shared by two users, user 1 and user 2. Table 1 shows permission data generated by the server 200 in response to different unlocking requests. As shown in Table 1, when user 1 sends an unlocking request to the server 200 corresponding to unmanned aerial vehicle A, the server 200 generates permission data A1 corresponding to user 1 and unmanned aerial vehicle A after receiving the unlocking request. When user 1 sends an unlocking request to the server 200 corresponding to unmanned aerial vehicle B, the server 200 generates permission data B1 corresponding to user 1 and unmanned aerial vehicle B after receiving the unlocking request. When user 2 sends an unlocking request to the server 200 corresponding to unmanned aerial vehicle A, the server 200 generates permission data A2 corresponding to user 2 and unmanned aerial vehicle A after receiving the unlocking request. When user 2 sends an unlocking request to the server 200 corresponding to unmanned aerial vehicle B, the server 200 generates permission data B2 corresponding to user 1 and unmanned aerial vehicle B after receiving the unlocking request.

In some embodiments, the permission data may include at least one permission packet, and each permission packet is used to permit a specific user to unlock a specific function. For example, the permission packet in permission data A1 can only be used by user 1 to execute unlocking. In some embodiments, the permission data may include at least one permission packet, and each permission packet is used to permit more than one specific user to unlock a specific function. In some embodiments, the permission data may include at least one permission packet, and each permission packet is used to permit a user to unlock more than one function. In some embodiments, the permission data may include at least one permission packet, and each permission packet is used to permit more than one user to unlock more than one function.

In some embodiments, the permission data may further include a period of validity corresponding to each permission packet. Only within the period of validity of the current permission packet, a specific function corresponding to the permission packet in the unmanned aerial vehicle 100 can be unlocked.

In some embodiments, the permission data may further include the number of permission packets included and/or the ID of the specific user. By adding the number of permission packets and/or the ID of the specific user to the permission data, it is convenient for the unmanned aerial vehicle 100 to verify the validity of the permission data, thereby preventing illegal tampering.

In some embodiments, the permission data may include at least one permission packet, and each permission packet is used to permit a specific user to unlock a specific function of a specific unmanned aerial vehicle 100. The permission packet may further include the ID of the specific unmanned aerial vehicle 100. For example, a permission packet A11 in the permission data A1 can only be used by user 1 to unlock function 1 of unmanned aerial vehicle A.

In some embodiments, the unmanned aerial vehicle system has a function of self-unlocking to unlock a specific function of the unmanned aerial vehicle 100, e.g., a flight restriction function, a specific route mode, a specific flight mode, a specific photographing function of a camera disposed on the unmanned aerial vehicle 100, etc.

In some embodiments, the method for unlocking a specific function of the unmanned aerial vehicle 100 is shown in FIG. 5B, where one method includes permission data application by the user and using by the user. In the permission data application process, the user submits information required for unlocking and prepares an unlocking request through a webpage. After the unlocking request is approved, the server 200 generates the permission data. In the permission data using process, the user can download the permission data from the server 200 through the terminal and import the permission data into the unmanned aerial vehicle 100. When the user needs to use the function of unlocking, the user can choose to open the permission packet corresponding to the function of unlocking.

In some embodiments, another method for unlocking a specific function of the unmanned aerial vehicle 100 is self-unlocking, as shown in FIG. 5C. User information is stored in the terminal, where the user information can be bank card information of the user (e.g., credit card information), identity information (e.g., ID card information or other information that can identify the identity of the user), mobile phone information, information registered by the user in a verification system, or other information that can identify the user. The terminal can use the stored information of the user to request to unlock a specific function of the unmanned aerial vehicle 100 without a need for the user to fill in the information required for unlocking. The user only needs to file an unlocking request. The terminal acquires the information of the user and other information required for unlocking according to the unlocking request, and automatically generates the unlocking request and send the request to the server. The unlocking method in some embodiments is more complicated than the unlocking method described above since the terminal 300 automatically helps the user to complete many processes that the user needs to operate in the method described above. For example, when the terminal acquires other information required for unlocking, specifically, the terminal 300 searches current flight restriction regions where the unmanned aerial vehicle 100 can be unlocked, transparently transmits the permission data to the unmanned aerial vehicle 100, and sends an instruction of opening to trigger the unmanned aerial vehicle 100 to open the permission data, etc. Through the series of operations, the legality and security of the self-unlocking can be improved.

In some embodiments, the self-unlocking function is used to unlock a specific flight restriction function of the unmanned aerial vehicle 100. The permission data may be used to instruct the unmanned aerial vehicle 100 to realize at least one of the functions including lifting the flight restriction of the unmanned aerial vehicle 100 within a specific flight restriction region, lifting the flight restriction of the unmanned aerial vehicle 100 within all flight restriction regions in a specific country, controlling the unmanned aerial vehicle 100 to fly only in a specific flight restriction region, and lifting an altitude restriction of the unmanned aerial vehicle 100 during flight. When the permission data is used to instruct the unmanned aerial vehicle 100 to realize the function of controlling the unmanned aerial vehicle 100 to fly only in a specific flight restriction region, the permission data includes information of a flight altitude of the unmanned aerial vehicle 100 and edge information of the region, that is, the unmanned aerial vehicle 100 is controlled to fly only at a specific altitude within a specific region. For example, a maximum flight altitude of the unmanned aerial vehicle 100 in the specific region is 50 m. It should be noted that unlocking a specific flight restriction function of the unmanned aerial vehicle 100 is not limited to the methods described above.

Further, when the self-unlocking function is used to unlock a specific flight restriction function of the unmanned aerial vehicle 100, before the terminal 300 sends the unlocking request to the server 200, it is needed to determine flight restriction regions that allow to lift the flight restriction corresponding to the current position of the unmanned aerial vehicle 100. The terminal 300 then sends the unlocking request to the server 200 according to the flight restriction regions that allow to lift the flight restriction, to ensure that the current unlocked specific flight restriction function of the unmanned aerial vehicle 100 is legal. The process of the terminal 300 determining flight restriction regions that allow to lift the flight restriction corresponding to the current position of the unmanned aerial vehicle 100 is as follows. The terminal 300 acquires real-time position information of the unmanned aerial vehicle 100, and acquires flight restriction regions within a specific range from the real-time position of the unmanned aerial vehicle 100 according to the real-time position information and the current flight restriction database of the unmanned aerial vehicle 100. At this point, the terminal 300 can obtain the flight restriction regions near the current position of the unmanned aerial vehicle 100 (within a specific range from the real-time position of the unmanned aerial vehicle 100). Further, the terminal 300 determines flight restriction regions that allow to lift the flight restriction from the obtained flight restriction regions according to a preset strategy. For example, in some embodiments, the terminal 300 may determine flight restriction regions that allow to lift the flight restriction from the obtained flight restriction regions according to security levels of the flight restriction regions. Specifically, a flight restriction region with a security level lower than a preset level is selected from the obtained flight restriction regions as the flight restriction region that allows to lift the flight restriction. In some embodiments, the terminal 300 may determine flight restriction regions that allow to lift the flight restriction from the obtained flight restriction regions according to area information where the current position of the unmanned aerial vehicle 100 is located. For example, when the area where the current position of the unmanned aerial vehicle 100 is located is a specific area, a specific model of the unmanned aerial vehicle 100 may be allowed to lift the flight restriction in the specific area, or an unmanned aerial vehicle 100 controlled by a specific user may be allowed to lift the flight restriction in the specific area. In some embodiments, the terminal 300 may determine flight restriction regions that allow to lift the flight restriction from the obtained flight restriction regions according to the ID of the unmanned aerial vehicle 100, which in turn determines flight restriction regions that allow to lift the flight restriction according to a grade of unmanned aerial vehicle 100. In some embodiments, the terminal 300 may determine flight restriction regions that allow to lift the flight restriction from the obtained flight restriction regions according to the ID of the user currently logged in, which in turn determines flight restriction regions that allow to lift the flight restriction according to the information of the user currently logged in. In some embodiments, the terminal 300 may determine flight restriction regions that allow to lift the flight restriction from the obtained flight restriction regions according to a management authority of the user currently logged in, which in turn determines flight restriction regions that allow to lift the flight restriction according to the authority of the user currently logged in. After determining the flight restriction regions that allow to lift the flight restriction corresponding to the current position of the unmanned aerial vehicle 100, the terminal 300 generates the unlocking request according to the flight restriction regions that allow to lift the flight restriction and sends the request to the server 200, and then obtains corresponding permission data from the server 200.

The transmission method of the permission data sent by the server 200 to the unmanned aerial vehicle 100 can be determined according to a connection status of the unmanned aerial vehicle 100. For example, when the unmanned aerial vehicle 100 is in an online status, the server 200 directly sends the permission data to the unmanned aerial vehicle 100; while when the unmanned aerial vehicle 100 is in an offline status, the server 200 transparently transmits the permission data to the unmanned aerial vehicle 100 through the terminal 300.

Further, in some embodiments, the server directly sends the permission data to the unmanned aerial vehicle 100 after receiving the unlocking request and generating the permission data.

In some embodiments, the server sends the permission data to the unmanned aerial vehicle 100 after receiving the unlocking request, generating the permission data, and receiving a importing request. The importing request carries the user ID of the user currently requesting and the ID of the unmanned aerial vehicle 100 to be imported with the permission data. The server 200 obtains the corresponding permission data according to the user ID and the ID of the unmanned aerial vehicle 100, and then sends the obtained permission data to the unmanned aerial vehicle 100. The importing request can be sent by the terminal 300 or the unmanned aerial vehicle 100 to the server 200.

At 502, the permission data is parsed and the parsed permission data is opened.

At 502, after the unmanned aerial vehicle 100 parses the permission data, the permission packet in the permission data does not take effect in real time. The unmanned aerial vehicle 100 needs to further open the parsed permission data to make at least part of the permission packet in the permission data effective. The method for the unmanned aerial vehicle 100 to parse the permission data is determined according to the permission data received by the unmanned aerial vehicle 100. For example, in some embodiments, the permission data received by the unmanned aerial vehicle 100 is encrypted by the server 200, and the unmanned aerial vehicle 100 needs to decrypt the received permission data to read the data after receiving the encrypted permission data.

Further, in some embodiments, the unmanned aerial vehicle 100 opening the parsed permission data is triggered by the terminal 300. The permission data can be selected to be opened according to the need of the user, which has high flexibility. Specifically, before the unmanned aerial vehicle 100 opens the parsed permission data, the method may further include receiving an instruction of opening sent by the terminal 300 indicating the permission data takes effect. For example, the instruction of opening can be used to instruct all the permission packets in the permission data to take effect, or to instruct a part of the permission packets in the permission data take effect. After receiving the instruction of opening, the unmanned aerial vehicle 100 selects the corresponding permission packet to take effect according to the instruction of opening, and a specific function corresponding to the permission packet in effective takes effect in the unmanned aerial vehicle 100.

In some embodiments, the instruction of opening carries the ID of the user currently managing the unmanned aerial vehicle 100. Before opening the parsed permission data, the unmanned aerial vehicle 100 needs to further analyze the instruction of opening and the permission data, to ensure the legality of the unlocking. For example, in some embodiments, the unmanned aerial vehicle 100 determines that an ID of a user corresponding to the permission data is the same as the ID of the user in the instruction of opening, and then opens the parsed permission data so that the permission packet corresponding to the parsed permission data takes effect. In some embodiments, the unmanned aerial vehicle 100 determines that a management authority of a user corresponding to the ID of the user in the instruction of opening is a preset authority, and then opens the parsed permission data so that the permission packet corresponding to the parsed permission data takes effect. The preset authority can be an administrator authority or a captain authority.

Further, after opening the parsed permission data, the unmanned aerial vehicle 100 can also be triggered by the terminal 300 to close the opened permission data, so as to disable a specific function that is unlocked but not needed of the unmanned aerial vehicle 100 in time, and hence improving the safety of the flight of the unmanned aerial vehicle 100. Specifically, after the unmanned aerial vehicle 100 opens the parsed permission data, the method may further include receiving an instruction of closing sent by the terminal 300 indicating the permission data becomes invalid, and closing the opened permission data.

In some embodiments, the instruction of closing carries the ID of the user currently controlling the unmanned aerial vehicle 100, and before the unmanned aerial vehicle 100 closes the opened permission data, the method may further include determining that the ID of the user corresponding to the permission data is the same as the ID of the user in the instruction of closing, to ensure the legality of the operation of disabling the unlocked specific function of the unmanned aerial vehicle 100, thereby further improving the safety of the flight of the unmanned aerial vehicle 100.

At 503, the flight of the unmanned aerial vehicle 100 is controlled according to the parsed permission data.

In some embodiments, the parsing and opening of the permission data is completed by the unmanned aerial vehicle 100, and the user may unlock the specific function of the unmanned aerial vehicle 100 according to the need, which has high flexibility.

When the permission data includes a period of validity corresponding to each permission packet, the process at 503 may specifically include determining that a permission packet is in effect based on the period of validity of the permission packet. In some embodiments, the unmanned aerial vehicle 100 controls the flight of the unmanned aerial vehicle 100 according to the permission in effect, and improves the safety of the flight of the unmanned aerial vehicle 100.

When the self-unlocking function is used to unlock the specific flight restriction function of the unmanned aerial vehicle 100, the process at 503 may specifically include controlling the flight of the unmanned aerial vehicle 100 according to the parsed permission data and the current flight restriction database of the unmanned aerial vehicle 100, improving the safety of the flight of the unmanned aerial vehicle 100, and meeting a specific need of the user. In some embodiments, the flight restriction database may be a dynamic flight restriction database. In some embodiments, the flight restriction database may be a dynamic flight restriction database and a static flight restriction database.

In another embodiment, there is provided an unmanned aerial vehicle control method. FIG. 7 is the flowchart of the method for controlling the unmanned aerial vehicle. The method can be implemented by, e.g., the server 200.

As shown in FIG. 7, the unmanned aerial vehicle control method includes the following processes.

At 701, an unlocking request is received, where the unlocking request carries a user ID of a user currently requesting and an ID of the current unmanned aerial vehicle 100.

The unlocking request can be sent by the terminal 300 to the server 200, or sent by the unmanned aerial vehicle 100 to the server 200.

At 702, permission data is generated in response to the unlocking request, where the permission data includes at least one permission packet, and each permission packet is used to permit to unlock a specific function of the unmanned aerial vehicle 100.

In some embodiments, after receiving the unlocking request, the server 200 generates the corresponding permission data according to the user ID of the user currently requesting and the ID of the current unmanned aerial vehicle 100. The description above can be referred to for details of the permission data, and will not be repeated here.

At 703, the permission data is sent to the current unmanned aerial vehicle 100.

In some embodiments, the parsing and opening of the permission data is completed by the unmanned aerial vehicle 100, and the user may unlock the specific function of the unmanned aerial vehicle 100 according to the need, which has high flexibility.

In some embodiments, the unlocking request is sent by the terminal 300 to the server 200, and the process at 703 may specifically include transparently transmitting the permission data to the unmanned aerial vehicle 100 through the terminal 300. In some embodiments, the terminal 300 does not implement any process to the permission data sent by the server 200 to the terminal 300, but directly forwards the permission data sent by the server 200 to the terminal 300 to the unmanned aerial vehicle 100. One or more permission packets in the permission data are opened by self-unlocking to unlock the required specific function of the unmanned aerial vehicle 100, which has high versatility.

In some embodiments, the unlocking request is directly sent by the unmanned aerial vehicle 100 to the server 200. The server 200 generates the permission data of the current unmanned aerial vehicle 100 in response to the unlocking request and directly sends the permission data to the unmanned aerial vehicle 100.

The transmission method of the permission data sent by the server 200 to the unmanned aerial vehicle 100 can be determined according to a connection status of the unmanned aerial vehicle 100. For example, when the unmanned aerial vehicle 100 is in an online status, the server 200 directly sends the permission data to the unmanned aerial vehicle 100; while when the unmanned aerial vehicle 100 is in an offline status, the server 200 transparently transmits the permission data to the unmanned aerial vehicle 100 through the terminal 300.

Further, after the server 200 executes 702 and before the server 200 executes 703, the method may further include encrypting the generated permission data. The server 200 executing 703 specifically includes sending the encrypted permission data to the current unmanned aerial vehicle 100, thereby preventing the data from being tampered and improving the security of the data.

Further, in some embodiments, the server directly sends the permission data to the unmanned aerial vehicle 100 after receiving the unlocking request and generating the permission data.

In some embodiments, the server sends the permission data to the unmanned aerial vehicle 100 after receiving the unlocking request, generating the permission data, and receiving a importing request. The importing request carries the user ID of the user currently requesting and the ID of the unmanned aerial vehicle 100 to be imported with the permission data. The server 200 obtains the corresponding permission data according to the user ID and the ID of the unmanned aerial vehicle 100, and then sends the obtained permission data to the unmanned aerial vehicle 100. The importing request can be sent by the terminal 300 or the unmanned aerial vehicle 100 to the server 200.

It should be noted that the execution process of the unmanned aerial vehicle 100 is described with reference to above embodiment, and will not be repeated here.

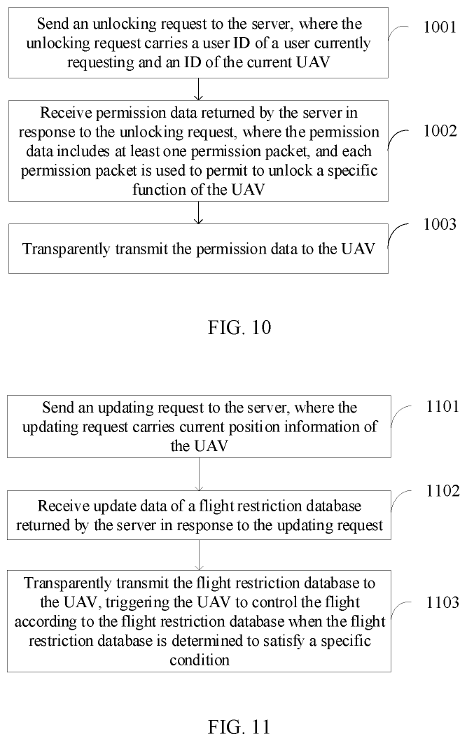

In another embodiment, there is provided an unmanned aerial vehicle control method. FIG. 10 is the flowchart of the method for controlling the unmanned aerial vehicle. The method can be implemented by, e.g., the terminal 300.

As shown in FIG. 10, the unmanned aerial vehicle control method includes the following processes.

At 1001, an unlocking request is sent to the server 200, where the unlocking request carries a user ID of a user currently requesting and an ID of the current unmanned aerial vehicle 100.

In some embodiments, the unmanned aerial vehicle system has a function of self-unlocking to unlock a specific function of the unmanned aerial vehicle 100, e.g., a flight restriction function, a specific route mode, a specific flight mode, a specific photographing function of a camera disposed on the unmanned aerial vehicle 100, etc.

When the self-unlocking function is used to unlock a specific flight restriction function of the unmanned aerial vehicle 100, before the terminal 300 sends the unlocking request to the server 200, it is needed to determine flight restriction regions that allow to lift the flight restriction corresponding to the current position of the unmanned aerial vehicle 100. The terminal 300 then sends the unlocking request to the server 200 according to the flight restriction regions that allow to lift the flight restriction, to ensure that the current unlocked specific flight restriction function of the unmanned aerial vehicle 100 is legal. The process of the terminal 300 determining flight restriction regions that allow to lift the flight restriction corresponding to the current position of the unmanned aerial vehicle 100 is as follows. The terminal 300 acquires real-time position information of the unmanned aerial vehicle 100, and acquires flight restriction regions within a specific range from the real-time position of the unmanned aerial vehicle 100 according to the real-time position information and the current flight restriction database of the unmanned aerial vehicle 100. At this point, the terminal 300 can obtain the flight restriction regions near the current position of the unmanned aerial vehicle 100 (within a specific range from the real-time position of the unmanned aerial vehicle 100). Further, the terminal 300 determines flight restriction regions that allow to lift the flight restriction from the obtained flight restriction regions according to a preset strategy. For example, in some embodiments, the terminal 300 may determine flight restriction regions that allow to lift the flight restriction from the obtained flight restriction regions according to security levels of the flight restriction regions. Specifically, a flight restriction region with a security level lower than a preset level is selected from the obtained flight restriction regions as the flight restriction region that allows to lift the flight restriction. In some embodiments, the terminal 300 may determine flight restriction regions that allow to lift the flight restriction from the obtained flight restriction regions according to area information where the current position of the unmanned aerial vehicle 100 is located. For example, when the area where the current position of the unmanned aerial vehicle 100 is located is a specific area, a specific model of the unmanned aerial vehicle 100 may be allowed to lift the flight restriction in the specific area, or an unmanned aerial vehicle 100 controlled by a specific user may be allowed to lift the flight restriction in the specific area. In some embodiments, the terminal 300 may determine flight restriction regions that allow to lift the flight restriction from the obtained flight restriction regions according to the ID of the unmanned aerial vehicle 100, which in turn determines flight restriction regions that allow to lift the flight restriction according to a grade of unmanned aerial vehicle 100. In some embodiments, the terminal 300 may determine flight restriction regions that allow to lift the flight restriction from the obtained flight restriction regions according to the ID of the user currently logged in, which in turn determines flight restriction regions that allow to lift the flight restriction according to the information of the user currently logged in. In some embodiments, the terminal 300 may determine flight restriction regions that allow to lift the flight restriction from the obtained flight restriction regions according to a management authority of the user currently logged in, which in turn determines flight restriction regions that allow to lift the flight restriction according to the authority of the user currently logged in. After determining the flight restriction regions that allow to lift the flight restriction corresponding to the current position of the unmanned aerial vehicle 100, the terminal 300 generates the unlocking request according to the flight restriction regions that allow to lift the flight restriction and sends the request to the server 200, and then obtains corresponding permission data from the server 200.

At 1002, permission data returned by the server 200 in response to the unlocking request is received, where the permission data includes at least one permission packet, and each permission packet is used to permit to unlock a specific function of the unmanned aerial vehicle 100.

In some embodiments, the permission data may include at least one permission packet, and each permission packet is used to permit a specific users to unlock a specific function. For example, a permission packet in permission data A1 can only be used by an user 1 to execute unlocking.

In some embodiments, the permission data may further include a period of validity corresponding to each permission packet. Only within the period of validity of the current permission packet, a specific function corresponding to the permission packet in the unmanned aerial vehicle 100 can be unlocked.

In some embodiments, the permission data may further include the number of permission packets included and/or the ID of the specific user. By adding the number of permission packets and/or the ID of the specific user to the permission data, it is convenient for the unmanned aerial vehicle 100 to verify the validity of the permission data, thereby preventing illegal tampering.

In some embodiments, the permission data may include at least one permission packet, and each permission packet is used to permit a specific users to unlock a specific function of a specific unmanned aerial vehicle 100. The permission packet may further include the ID of the specific unmanned aerial vehicle 100. For example, a permission packet A11 in the permission data A1 can only be used by user 1 to unlock function 1 of unmanned aerial vehicle A.

In some embodiments, the self-unlocking function is used to unlock a specific flight restriction function of the unmanned aerial vehicle 100. The permission data may be used to instruct the unmanned aerial vehicle 100 to realize at least one of the functions including lifting the flight restriction of the unmanned aerial vehicle 100 within a specific flight restriction region, lifting the flight restriction of the unmanned aerial vehicle 100 within all flight restriction regions in a specific country, controlling the unmanned aerial vehicle 100 to fly only in a specific flight restriction region, and lifting an altitude restriction of the unmanned aerial vehicle 100 during flight. When the permission data is used to instruct the unmanned aerial vehicle 100 to realize the function of controlling the unmanned aerial vehicle 100 to fly only in a specific flight restriction region, the permission data includes information of a flight altitude of the unmanned aerial vehicle 100 and edge information of the region, that is, the unmanned aerial vehicle 100 is controlled to fly only at a specific altitude within a specific region. For example, a maximum flight altitude of the unmanned aerial vehicle 100 in the specific region is 50 m. It should be noted that unlocking a specific flight restriction function of the unmanned aerial vehicle 100 is not limited to the methods described above.

At 1003, the permission data is transparently transmitted to the unmanned aerial vehicle 100.

In some embodiments, the terminal 300 does not implement any process to the permission data sent by the server 200 to the terminal 300, but directly forwards the permission data sent by the server 200 to the terminal 300 to the unmanned aerial vehicle 100. Then one or more permission packets in the permission data are opened by self-unlocking to unlock the required specific function of the unmanned aerial vehicle 100, which has high versatility.

In some embodiments, after 1003, the method further includes sending an instruction of opening indicating the permission data takes effect to the unmanned aerial vehicle 100. In some embodiments, after the terminal 300 transparently transmits the permission data to the unmanned aerial vehicle 100, the permission data has not taken effect in the unmanned aerial vehicle 100. A trigger by the terminal 300 is needed to enable the unmanned aerial vehicle 100 to open at least part of the permission packets in the permission data and make these permission packets to take effect in the unmanned aerial vehicle 100, which has high flexibility. In some embodiments, the instruction of opening carries the ID of the user currently managing the unmanned aerial vehicle 100. The unmanned aerial vehicle 100 can further determine the legality of the instruction of opening according to the ID of the user in the instruction of opening, and open the corresponding permission data after ensuring that the instruction of opening is legal, so as to improve the safety of the unmanned aerial vehicle 100.

Further, after 1003, the method includes sending an instruction of closing indicating the permission data becomes invalid to the unmanned aerial vehicle 100, so as to disable a specific function that is unlocked but not needed of the unmanned aerial vehicle 100 in time, and hence improving the safety of the flight of the unmanned aerial vehicle 100. In some embodiments, the instruction of closing carries the ID of the user currently controlling the unmanned aerial vehicle 100. The unmanned aerial vehicle 100 can further determine the legality of the instruction of closing according to the ID of the user in the instruction of closing, and close the corresponding permission data after ensuring that the instruction of closing is legal, so as to improve the safety of the unmanned aerial vehicle 100.

With reference to FIG. 11, the method further includes the following processes.

At 1101, an updating request is sent to the server 200, where the updating request carries current position information of the unmanned aerial vehicle 100.

In some embodiments, after receiving the updating request, the server 200 parses out current position information of the unmanned aerial vehicle 100 from the updating request. Then the server 200 directly sends the latest flight restriction database in the server 200 to the unmanned aerial vehicle 100 according to the current position information of the unmanned aerial vehicle 100, or selects the update data of the flight restriction database of the unmanned aerial vehicle 100 corresponding to the current position information from the dynamic update database of the server 200 and sends the update data to the terminal 300.

In some embodiments, the flight restriction database is a dynamic flight restriction database.

In some embodiments, the flight restriction database does not distinguish between a dynamic flight restriction database and a static flight restriction database. The flight restriction database may include both a dynamic flight restriction database and a static flight restriction database.

The following embodiment will be described by taking the flight restriction database as a dynamic flight restriction database as an example.

The updating request carrying the current position information of the unmanned aerial vehicle 100 is sent to the server 200 through the terminal 300, and the flight restriction data of the flight restriction region in the area where the current position of the unmanned aerial vehicle 100 is located is obtained from the server 200 in time, so as to improve the accuracy and timeliness of the flight restriction data of the temporary flight restriction region. Further, determining the update data of the flight restriction database of the unmanned aerial vehicle 100 according to the position information can also prevent the amount of the requested update data of the flight restriction database of the unmanned aerial vehicle 100 being too large.

The update data of the flight restriction database includes at least one range information of the temporary flight restriction region and a period of validity. The range information of the temporary flight restriction region is a parameter for determining the flight restriction range of the temporary flight restriction region. In some embodiments, the range information of the temporary flight restriction region may be edge information of the temporary flight restriction region. In some embodiments, the range information of the temporary flight restriction region may be a center position and a radius of the temporary flight restriction region. The range information of the temporary flight restriction region can further be other parameters that can determine the flight restriction range of the temporary flight restriction region. Specifically, an expression form of the range information of the temporary flight restriction region can be selected according to a shape of the temporary flight restriction region. For example, the temporary flight restriction region is a regular circle, and the range information of the circular temporary flight restriction region can be expressed by the edge information of the temporary flight restriction region or the center position and the radius of the temporary flight restriction region. For another example, if the temporary flight restriction region is irregular in shape, the range information of the irregular temporary flight restriction region may be expressed by the edge information of the temporary flight restriction region. The period of validity of the temporary flight restriction region includes a start time and an end time. For the dynamic flight restriction database in the current unmanned aerial vehicle 100, the temporary flight restriction region takes effect in the period between the start time and the end time, and the unmanned aerial vehicle 100 is prohibited from flying in the temporary flight restriction region. Before the start time or after the end time, the temporary flight restriction region is invalid, and the unmanned aerial vehicle 100 can fly in the temporary flight restriction region.

The current position information of the unmanned aerial vehicle 100 can be obtained by a GPS device on the unmanned aerial vehicle 100 and sent to the terminal 300, or can be obtained by positioning of the terminal 300. In some embodiments, the position information may be latitude and longitude but is not limited to this. In other embodiments, the position information may be other parameters that can represent the position, e.g., administrative area information.

At 1102, update data of a flight restriction database returned by the server 200 in response to the updating request is received.

In some embodiments, the update data of the flight restriction database is received by the terminal 300.

The update data of a dynamic data obtained at 1102 is information of all temporary flight restriction region in a relatively large area, e.g., information of all temporary flight restriction regions in a country where a current position of an unmanned aerial vehicle 100 is located, information of all temporary flight restriction regions in a state (province) where a current position of an unmanned aerial vehicle 100 is located, or information of all temporary flight restriction regions within 20 km from a current position of an unmanned aerial vehicle 100 is located, etc.

At 1103, the flight restriction database is transparently transmitted to the unmanned aerial vehicle 100, triggering the unmanned aerial vehicle 100 to control the flight according to the flight restriction database when the flight restriction database is determined to satisfy a specific condition.

In some embodiments, the terminal 300 directly forwards the permission data sent by the server 200 to the terminal 300 to the unmanned aerial vehicle 100, and the unmanned aerial vehicle 100 judges the update data of the flight restriction database, thereby improving the safety of the flight of the unmanned aerial vehicle 100. In some embodiments, the terminal 300 performs a signature verification on the permission data sent by the server 200 to the terminal 300, and sends the permission data to the unmanned aerial vehicle 100 after the verification is successful. The method for the terminal to perform the signature verification on the permission data is similar to the method of the signature verification on the received update data of the flight restriction database by the unmanned aerial vehicle 100 in the embodiment described above, and will not be repeated here.

The execution processes of the unmanned aerial vehicle 100 and the server 200 are described with reference to above embodiments, and will not be repeated here.

In another embodiment, in response to the unmanned aerial vehicle control method in above embodiments, there is provided an unmanned aerial vehicle control device that can be applied to an unmanned aerial vehicle 100.

With reference to FIG. 8 and FIG. 9, there is provided an unmanned aerial vehicle control device including a first storage device 110 and a first processor 120 (e.g., a single-core or a multi-core processor).

The first storage device 110 may include a volatile memory, e.g., a random-access memory (RAM), a non-volatile memory, e.g., a flash memory, a hard disk drive (HDD)o, or a solid-state drive (SSD). The first storage device 110 may also include a combination of the above described types of memory.

The first processor 120 can be a central processing unit (CPU). The first processor 120 may further include a hardware chip that may be an application-specific integrated circuit (ASIC), a programmable logic device (PLD), or a combination thereof. The programmable logic device may be a complex programmable logic device (CPLD), a field-programmable gate array (FPGA), a generic array logic (GAL), or an any combination thereof.

In some embodiments, the first storage device 110 is configured to store a program instruction. One or more of the first processors 120 may be included, and may work individually or together. The first processor 120 calls the program instruction, and the execution of the program instruction implements the processes of the unmanned aerial vehicle control method described above.

The embodiments described above can be referred to for details of the method, and will not be repeated here.

In another embodiment, in response to the unmanned aerial vehicle control method in above embodiments, there is provided an unmanned aerial vehicle control device that can be applied to a server 200.

With reference to FIG. 8 and FIG. 9, there is provided an unmanned aerial vehicle control device including a second storage device 210 and a second processor 220 (e.g., a single-core or a multi-core processor).

The second storage device 210 may include a volatile memory, e.g., a random-access memory (RAM), a non-volatile memory, e.g., a flash memory, a hard disk drive (HDD)o, or a solid-state drive (SSD). The second storage device 210 may also include a combination of the above described types of memory.

The second processor 220 can be a central processing unit (CPU). The second processor 220 may further include a hardware chip that may be an application-specific integrated circuit (ASIC), a programmable logic device (PLD), or a combination thereof. The programmable logic device may be a complex programmable logic device (CPLD), a field-programmable gate array (FPGA), a generic array logic (GAL), or an any combination thereof.

In some embodiments, the second storage device 210 is configured to store a program instruction. One or more of the second processors 220 may be included, and may work individually or together. The second processor 220 calls the program instruction, and the execution of the program instruction implements the processes of the unmanned aerial vehicle control method described above.

The embodiments described above can be referred to for details of the method, and will not be repeated here.

In another embodiment, in response to the unmanned aerial vehicle control method in above embodiments, there is provided an unmanned aerial vehicle control device that can be applied to a terminal 300.

With reference to FIG. 9, there is provided an unmanned aerial vehicle control device including a third storage device 310 and a third processor 320 (e.g., a single-core or a multi-core processor).

The third storage device 310 may include a volatile memory, e.g., a random-access memory (RAM), a non-volatile memory, e.g., a flash memory, a hard disk drive (HDD)o, or a solid-state drive (SSD). The third storage device 310 may also include a combination of the above described types of memory.

The third processor 320 can be a central processing unit (CPU). The third processor 320 may further include a hardware chip that may be an application-specific integrated circuit (ASIC), a programmable logic device (PLD), or a combination thereof. The programmable logic device may be a complex programmable logic device (CPLD), a field-programmable gate array (FPGA), a generic array logic (GAL), or an any combination thereof.

In some embodiments, the third storage device 310 is configured to store a program instruction. One or more of the third processors 320 may be included, and may work individually or together. The third processor 320 calls the program instruction, and the execution of the program instruction implements the processes of the unmanned aerial vehicle control method described above.

The embodiments described above can be referred to for details of the method, and will not be repeated here.

In another embodiment, there is provided a computer-readable storage medium storing a computer program, and the execution of the program by the first processor, the second processor and the third processor implements the processes of the unmanned aerial vehicle control methods described above.

It should be noted that in the case of no conflict, the features of the above described embodiments can be combined with each other.

Those of ordinary skill in the art can understand that all or some of the processes of the above implementation method can be completed by a program instructing related hardware. The program can be stored in a computer-readable storage medium. When the program is being executed, processes of above described method embodiments can be included. The storage medium may be a magnetic disk, an optical disk, a read-only memory (ROM), or a random access memory (RAM), etc.

The device embodiment corresponds to and may refer to the description of the method embodiment. The devices described above are merely illustrative. The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure. Those of ordinary skill can understand and implement without creative work.

The terms of “an embodiment” or “one embodiment” indicates a particular feature, structure, or characteristic related to the embodiment is included in at least one embodiment of the present disclosure. In this specification, the schematic descriptions of the terms are not necessarily referring to the same embodiment. Furthermore, the particular feature, structure, or characteristic may be combined in any suitable manner in one or more embodiments.

Any process or method description in a flowchart or otherwise described herein can be understood as representing a module, fragment, or portion of code that includes one or more executable instruction for implementing a particular logical function or a process. The scope of the embodiments of the present disclosure includes additional implementations in which the functions may be performed out of the order shown or discussed, including performing functions in a substantially simultaneous manner or in the reverse order according to the functions involved, which should be understood by those skilled in the art.

The logic and/or process represented in the flowchart or otherwise described herein, for example, a sequenced list of executable instruction that can be considered to implement a logical function, can be embodied in any computer-readable medium and used by an instruction execution system, device, or device (e.g., a computer-based system, a system including a processor, or other systems that can fetch and execute instruction from an instruction execution system, device, or equipment), or can be used in combination with these instruction execution systems, devices or equipment. In this specification, a “computer-readable medium” may be any device that can contain, store, communicate, propagate, or transmit a program for use by or in connection with an instruction execution system, device or equipment. A more specific example (non-exhaustive list) of computer-readable media can include, electrical connection (electronic device) with one or more wires, portable computer disk enclosure (magnetic device), random access memory (RAM), read-only memory (ROM), erasable and programmable read-only memory (EPROM or Flash memory), fiber optic devices, and portable compact disc read-only memory (CDROM). The computer-readable medium may further be paper or other suitable medium on which the program can be printed, as it can be performed, for example, by optically scanning the paper or other medium, followed by editing, interpretation, or other suitable method if necessary to process to obtain the program electronically and then store it in computer memory.

It should be understood that each part of the present disclosure may be implemented by hardware, software, firmware, or a combination thereof. In the above embodiments, multiple processes or methods may be implemented by software or firmware stored in a memory and executed by a suitable instruction execution system. For example, if implemented in hardware, as in another embodiment, it may be implemented using any one or a combination of the following techniques known in the art, e.g., discrete logic circuits with logic gate circuits for implementing logic functions on data signals, special-purpose integrated circuits with suitable combinational logic gate circuits, programmable gate arrays (PGA), and field programmable gate arrays (FPGA), etc.

Those of ordinary skill in the art can understand that all or some of the processes of the above implementation method can be completed by a program instructing related hardware. The program can be stored in a computer-readable storage medium. When the program is being executed, one or a combination of processes of a method embodiment can be included.

In addition, the functional units in the various embodiments of the present disclosure may be integrated in one processing unit, or each unit may be an individual physically unit, or a plurality of units may be integrated in one unit. The above integrated modules can be implemented in the form of hardware or software functional modules. A method consistent with the disclosure can be implemented in the form of computer program stored in a non-transitory computer-readable storage medium, which can be sold or used as a standalone product.

The above described storage medium may be a read-only memory, a magnetic disk or an optical disk, etc. Although the embodiments of the present disclosure have been shown and described above, it can be understood that the above embodiments are exemplary and should not be construed as limitations on the present disclosure. Those skilled in the art can change, modify, substitute, and transform the above embodiments within the scope of the present disclosure.

What is claimed is:

1. A method for controlling an unmanned aerial vehicle comprising:
receiving update data of a flight restriction database of the unmanned aerial vehicle returned by a server in response to an updating request, the updating request carrying current position information of the unmanned aerial vehicle; and
controlling, in response to determining that the update data satisfies a condition, flight of the unmanned aerial vehicle according to the update data.

2. The method of claim 1, wherein determining that the update data satisfies the condition includes:
obtaining real-time position information of the unmanned aerial vehicle;
obtaining a flight restriction region within a specific range from a real-time position of the unmanned aerial vehicle according to the real-time position information and the update data; and
determining that a current time is within a valid period of the flight restriction region.

3. The method of claim 1, wherein determining that the update data satisfies the condition includes successfully verifying a signature of the update data.

4. The method of claim 3, wherein:
the update data is encrypted; and
determining that the update data satisfies the condition includes successfully decrypting the update data according to a preset rule.

5. The method of claim 1, further comprising, after determining that the update data satisfies the condition:
saving the update data to the flight restriction database by overwriting corresponding existing data in the flight restriction database.

6. The method of claim 1, wherein the flight restriction database is a dynamic flight restriction database of the unmanned aerial vehicle and the unmanned aerial vehicle further includes a static flight restriction database.

7. The method of claim 1, further comprising:
receiving permission data of the unmanned aerial vehicle sent by the server in response to an unlocking request, the unlocking request carrying a user ID of a user requesting unlocking and an ID of the unmanned aerial vehicle, the permission data including a permission packet used to unlock a function of the unmanned aerial vehicle;
parsing the permission data to obtain parsed permission data and opening the parsed permission data; and
controlling the flight of the unmanned aerial vehicle according to the parsed permission data.

8. The method of claim 7, further comprising:
receiving an opening instruction sent by a terminal indicating the permission data takes effect, the opening instruction carrying a user ID of a user managing the unmanned aerial vehicle;
wherein parsing the permission data includes:
determining that a user ID corresponding to the permission data is same as the user ID in the opening instruction of opening; or
determining that a user management authority corresponding to the user ID in the opening instruction is a preset authority.

9. The method of claim 7, further comprising, after opening the parsed permission data:
receiving a closing instruction sent by a terminal indicating the permission data becomes invalid; and
closing the permission data.

10. The method of claim 9,
wherein the closing instruction carries a user ID of a user controlling the unmanned aerial vehicle;
the method further comprising, before closing the permission data:
determining that a user ID corresponding to the permission data is same as the user ID in the closing instruction.

11. The method of claim 7, wherein the permission packet is configured to permit a specific user to unlock the function.

12. The method of claim 11, wherein:
the permission data includes a valid period corresponding to the permission packet; and
controlling the flight of the unmanned aerial vehicle according to the parsed permission data includes:
determining that the permission packet is in effect based on the valid period of the permission packet.

13. The method of claim 11, wherein the permission packet is one of one or more permission packets in the permission data, and the permission data further includes at least one of a number of the permission packets or a user ID of the specific user.

14. The method of claim 11, wherein the permission packet includes an ID of the unmanned aerial vehicle.

15. The method of claim 7, wherein the permission data is configured to instruct the unmanned aerial vehicle to perform at least one of:
lifting flight restriction of the unmanned aerial vehicle within one flight restriction region;
lifting flight restriction of the unmanned aerial vehicle within all flight restriction regions in a country;
controlling the unmanned aerial vehicle to fly only in one flight restriction region; or
lifting an altitude restriction of the unmanned aerial vehicle during flight.

16. The method of claim 15, wherein controlling the flight of the unmanned aerial vehicle according to the parsed permission data includes controlling the flight of the unmanned aerial vehicle according to the parsed permission data and the flight restriction database of the unmanned aerial vehicle.

17. The method of claim 16, wherein the permission data instructs to control the unmanned aerial vehicle to fly only in a specific flight restriction region, and the permission data includes flight altitude information for the unmanned aerial vehicle and edge information of the specific flight restriction region.

18. A device for controlling an unmanned aerial vehicle comprising:
a storage device storing program instructions; and
a processor configured to execute the program instructions to:
receive update data of a flight restriction database of the unmanned aerial vehicle returned by a server in response to an updating request, the updating request carrying current position information of the unmanned aerial vehicle; and
control, in response to determining that the update data satisfies a condition, flight of the unmanned aerial vehicle according to the update data.

19. The device of claim 18, wherein the processor is further configured to determine that the update data satisfies the condition by:
obtaining real-time position information of the unmanned aerial vehicle;
obtaining a flight restriction region within a specific range from a real-time position of the unmanned aerial vehicle according to the real-time position information and the update data; and
determining that a current time is within a valid period of the flight restriction region.

20. The device of claim 18, wherein the processor is further configured to determine that the update data satisfies the condition by successfully verifying a signature of the update data.

21. The device of claim 20, wherein:
the update data is encrypted; and
the processor is further configured to determine that the update data satisfies the condition by successfully decrypting the update data according to a preset rule.
